(19) United States
(12) Patent Application Publication
(10) Pub. No.: US 2023/0169126 A1
(43) Pub. Date: Jun. 1, 2023

(54) SYSTEM AND METHOD FOR MANAGED DATA SERVICES ON CLOUD PLATFORMS

(71) Applicant: Goldman Sachs & Co. LLC, New York, NY (US)

(72) Inventors: Dave Poston, London (GB); Timothy Mersov, Fair Lawn, NJ (US); Kevin Bajorin, New York, NY (US); Vipin Jain, Jersey City, NJ (US)

(21) Appl. No.: 18/059,891

(22) Filed: Nov. 29, 2022

Related U.S. Application Data
(60) Provisional application No. 63/283,985, filed on Nov. 29, 2021.
(60) Provisional application No. 63/283,994, filed on Nov. 29, 2021.

(51) Int. Cl. G06F 16/906; G06F 16/907

(52) U.S. Cl. CPC G06F 16/906; G06F 16/907

(57) ABSTRACT

A method includes receiving a request to create a managed data service on a cloud platform. The method also includes sending at least one instruction to the cloud platform for creating metadata for a set of data clusters in a database accessible by the cloud platform. The method also includes sending at least one instruction to the cloud platform to initiate creation of one or more user accounts on the cloud platform. The method also includes sending at least one instruction for configuring a multi-tier database on the cloud platform. The method also includes causing deployment of the set of data clusters on the cloud platform using a cloud formation template, wherein each data cluster has access to the multi-tier database. The method also includes sending at least one instruction to the cloud platform for making the set of data clusters available for receiving and processing requests.

### CROSS-REFERENCE TO RELATED APPLICATION AND PRIORITY CLAIM

This application claims priority under 35 U.S.C. § 119(e) to U.S. Provisional Patent Application No. 63/283,985 filed on Nov. 29, 2021 and to U.S. Provisional Patent Application No. 63/283,994 filed on Nov. 29, 2021, which are hereby incorporated by reference in their entirety.

### TECHNICAL FIELD

This disclosure relates generally to cloud computing and database systems. More specifically, this disclosure relates to a system and method for managed data services on cloud platforms.

### BACKGROUND

Organizations often analyze various information such as market data, Internet of Things (IoT) data measurements, user interaction data, sales data, supply and demand data, and so on. Many organizations need to deal with bitemporal data, that is, they need to know both when something happened (such as a price update), and when they saw it in their systems. However, existing systems lack the ability to delivery this information at scale, where there can be 700 billion updates per day across 150 markets, for example. Existing systems also lack the ability to provide this data with resiliency. If a component goes down, even for a short period of time, this cannot simply be ignored, as all subsequent data analysis will be affected by the loss of data during component down time.

### SUMMARY

This disclosure relates to a system and method for managed data services on cloud platforms.

In a first embodiment, a method includes receiving a request to create a managed data service on a cloud platform. The method also includes sending at least one instruction to the cloud platform for creating metadata for a set of data clusters in a database accessible by the cloud platform. The method also includes sending at least one instruction to the cloud platform to initiate creation of one or more user accounts on the cloud platform. The method also includes sending at least one instruction for configuring a multi-tier database on the cloud platform. The method also includes causing deployment of the set of data clusters on the cloud platform using a cloud formation template, wherein each data cluster is created using the one or more user accounts and each data cluster has access to the multi-tier database. The method also includes sending at least one instruction to the cloud platform for making the set of data clusters available for receiving and processing requests.

In a second embodiment, an apparatus includes at least one processor supporting managed data services. The at least one processor is configured to receive a request to create a managed data service on a cloud platform. The at least one processor is also configured to send at least one instruction to the cloud platform for creating metadata for a set of data clusters in a database accessible by the cloud platform. The at least one processor is also configured to send at least one instruction to the cloud platform to initiate creation of one or more user accounts on the cloud platform. The at least one processor is also configured to send at least one instruction for configuring a multi-tier database on the cloud platform. The at least one processor is also configured to cause deployment of the set of data clusters on the cloud platform using a cloud formation template, wherein each data cluster is created using the one or more user accounts and each data cluster has access to the multi-tier database. The at least one processor is also configured to send at least one instruction to the cloud platform for making the set of data clusters available for receiving and processing requests.

In a third embodiment, a non-transitory computer readable medium contains instructions that support managed data services and that when executed cause at least one processor to receive a request to create a managed data service on a cloud platform. The instructions when executed also cause the at least one processor to send at least one instruction to the cloud platform for creating metadata for a set of data clusters in a database accessible by the cloud platform. The instructions when executed also cause the at least one processor to send at least one instruction to the cloud platform to initiate creation of one or more user accounts on the cloud platform. The instructions when executed also cause the at least one processor to send at least one instruction for configuring a multi-tier database on the cloud platform. The instructions when executed also cause the at least one processor to cause deployment of the set of data clusters on the cloud platform using a cloud formation template, wherein each data cluster is created using the one or more user accounts and each data cluster has access to the multi-tier database. The instructions when executed also cause the at least one processor to send at least one instruction to the cloud platform for making the set of data clusters available for receiving and processing requests.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

In some embodiments, the term cluster (or data cluster) represents a cluster of nodes that orchestrate the storage and retrieval of timeseries data and perform operations such as sharding, replication, and execution of native timeseries functionalities in the managed data service. In some embodiments, a DB (Loader) represents a logical grouping of similar types of timeseries data. In some embodiments, a data set represents a logical grouping of one or more timeseries sharing a schema, frequency, and associated entity. In some embodiments, a timeseries (or series) represents a time-ordered sequence of rows (or records or tuples). In some embodiments, a row represents a grouping of columns for a particular date and symbol. In some embodiments, symbol dimensions represent a primary dimension that a timeseries or timetable is indexed on (other than time). For example, in finance, this is typically an asset identifier such as a stock symbol. In some embodiments, non-symbol dimensions represent contextual or pivot columns. In some embodiments, measures represent numerical columns for executing univariate or multivariate timeseries expressions on. In some embodiments, a timetable represents a dataset mode that supports multi-dimensional timeseries and matrices.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example system supporting managed data services on cloud platforms in accordance with this disclosure;

FIG. 2 illustrates an example device supporting managed data services on cloud platforms in accordance with this disclosure;

FIG. 3 illustrates an example computer system within which instructions for causing an electronic device to perform any one or more of the methodologies discussed herein may be executed;

FIGS. 4A through 4C illustrate an example functional architecture for managed data services on cloud platforms in accordance with this disclosure;

FIG. 5 illustrates an example logically-divided architecture for managed data services on cloud platforms in accordance with this disclosure;

FIG. 6 illustrates an example cluster creation process in accordance with embodiments of this disclosure;

FIG. 7 illustrates an example high-level managed services architecture in accordance with this disclosure

FIGS. 8A and 8B illustrate example managed services paradigms in accordance with this disclosure;

FIG. 9 illustrates an example shared services architecture in accordance with this disclosure;

FIGS. 10A and 10B illustrate an example clustering architecture in accordance with this disclosure;

FIG. 11 illustrates an example process for serving real-time timeseries data in accordance with embodiments of this disclosure;

FIG. 12 illustrates an example timeseries data format in accordance with this disclosure;

FIG. 13 illustrates an example data query anatomy in accordance with this disclosure;

FIG. 14 illustrates an example multi-tier database/storage architecture in accordance with this disclosure;

FIG. 15 illustrates an example temporal storage tier chart in accordance with this disclosure;

FIG. 16 illustrates an example data analysis user interface in accordance with this disclosure;

FIG. 17 illustrates an example data catalog user interface in accordance with this disclosure;

FIG. 18 illustrates an example data sharing architecture in accordance with this disclosure; and

FIGS. 19A and 19B illustrate an example method for deploying and executing managed data services in accordance with this disclosure.

### DETAILED DESCRIPTION

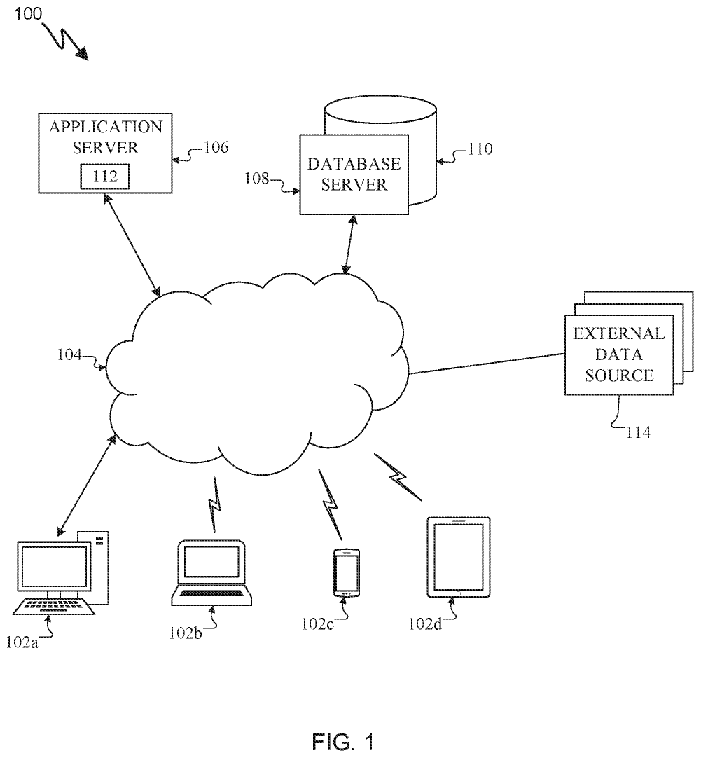

FIGS. 1 through 19B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, organizations often analyze various information such as market data, Internet of Things (IoT) data measurements, user interaction data, sales data, supply and demand data, and so on. Many organizations need to deal with bitemporal data, that is, they need to know both when something happened (such as a price update), and when they saw it in their systems. However, existing systems lack the ability to delivery this information at scale, where there can be 700 billion updates per day across 150 markets, for example. Existing systems also lack the ability to provide this data with resiliency. If a component goes down, even for a short period of time, this cannot simply be ignored, as all subsequent data analysis will be affected by the loss of data during component down time.

Organizations may generate and process timeseries data that is received in real-time, such as data generated by IoT sensors, market data, user interaction data, data generated by instrumented software, and so on. Timeseries data is data that is a sequence of data points indexed on time, often at high rates of ingestion with the most recently ingested data the most likely to be queried. Timeseries data often has several typical attributes including that the data is append only data, is time-indexed or time-ordered, and includes one or more measurements. Market data can also be formatted as timeseries data, but also has a set of access patterns and workloads that cause timeseries market data to have additional attributes including versioned (bitemporal) timeseries attributes, frequent out of order writes causing historical backfills, and additional time indices (such as exchange time vs data capture time). Also, raw market data can be challenging to consume and has unique normalization challenges.

As one example, corporations such as airlines and auto manufacturers have a high demand for materials, including aluminum for construction and nickel for battery production These require energy to fabricate. Thus, these different market participants need to manage their supply and demand economics, as they are exposed to the economy as a whole, and they have price fluctuations which they may want to hedge. The embodiments of this disclosure provide systems and methods to provide real-time data in a resilient manner to assist organizations with gathering and analyzing data that can be used, for example, to manage the risk of changes in inventory and asset prices.

Traditionally, an inordinate amount of time is spent finding, cleaning and organizing or maintaining data feeds, such as up to 80%, leaving little time to spend performing data analysis. This is because onboarding a typical data feed often involves needing to find data which is suitable for our specific problem, including scouring options, determining licensing models, evaluating feeds, and negotiating pricing or legal terms. Then, the data feed can be provided as a dump of history, often across hundreds of files, with formats that have changed through time, and often has random inconsistencies. The data thus then has to be cleaned and organized, including attempting to map feeds to consistent data models and join the data to other sources for analysis. Data quality also has to be validated such as by running assurance checks (late or missing data). Semantic checks also have to be performed such as validating index weights price to the published level, or mapping company lineage through corporate actions. This is an ongoing process as a feed evolves, so the cost generally increases the more data that consumed. Additionally, sourcing a large number of data feeds can cause issues such as duplicate data sourcing, often with completely different data models, orphaned feeds which lack owners, and data feeds with ongoing costs that are rarely or never used. There is thus a need for a system for data sourcing and analysis that provides rapid onboarding times, straightforward discovery and immediate data access using common data models (upload once, use many times), and entitlements and metrics to ensure compliance and cost optimizations.

Embodiments of this disclosure provide a system that receives timeseries data and processes it, for example, to answer queries or to generate reports. There may be billions of operations performed by the system in a day. The system stores the data in a data store referred to herein as a tick database. The system uses a multi-tier architecture to support different access patterns depending on the recency of the data, including (1) memory for allowing fast access to the most recent timeseries data, (2) SSD (solid state drive) for medium term access, and (3) cheaper storage solutions for deeper history data. The system includes a distributed setup with many nodes running in parallel.

Benefits of the database architecture of this disclosure also include access to deep daily history (such as providing multiple years of daily data such as close prices or volatility curves), intraday data (such as five-minute snapshots of point-in-time calculations or non-snapshot intraday ticking market data such as exchange bids and asks), bitemporal features (such as queries as of a certain time, supporting a transaction time in addition to a valid time), various database types providing various database schema and storage models (such as timeseries or columnar), ability to scale to different workloads, fast writes per second, write quotas, multiple measures per row (multiple numeric measures that can have timeseries functions applied in parallel), on-disk compression, data backfill capabilities (ability to upsert data while continuing to ingest data such as real-time backfill such that each transaction fits in RAM, ability to backfill during a power or communications outage), high timestamp granularity (nanoseconds), downsampling of data (such as downsampling 150,000 ticks to 1 minute bar data for interactive analysis and visualization), providing volume weighted averages, providing time weighted averages, ability to perform aggregation calculations including sum, min, max, etc., and ability to store volatility curves.

Data is replicated across nodes to ensure they can be fault tolerant and scale horizontally. Each node in turn has a microservice process setup, handling different parts of the data workflow. Starting from the bottom up, the microservices handle everything from data ingestion such as the collector processes, all the way to actually serving the data to client requests with the tick-server processes. This ensures that the system can serve requests at low latency, even during spikes in requests processed. The system may be implemented on either a propriety cloud platform or a hosted cloud platform. Different availability zones can be used for isolation and failover, which provides resiliency in order to be able to handle live transactions. If any components or processes go down or fail, live data can still be accessed or quickly backfilled in real-time so that data analyses are not affected by the failure.

Data for use by the systems and methods of this disclosure can be sourced from various sources, cleaned, evaluated using various evaluation tools or processes, and plotted or otherwise presented in real-time, down to nanosecond granularity. The systems and methods of this disclosure thus allow for managing vast amounts of data, updating in real-time. The different data sources can be integrated and modeled to speed up the time between identifying new data sources and when value can be derived value from the new data sources. The infrastructure can be deployed on demand using cloud formation templates, computation and storage can be dynamically adjusted to manage peak volumes efficiently, the latest real-time data from multiple sources can be accessed natively in the cloud, the infrastructure is secure due to isolating instanced components and leveraging cloud security protocols, and collaboration between clients or users can be enhanced by the sharing of resources.

FIG. 1 illustrates an example system 100 supporting managed data services on cloud platforms in accordance with this disclosure. As shown in FIG. 1, the system 100 includes multiple user devices 102a-102d such as electronic computing devices, at least one network 104, at least one application server 106, and at least one database server 108 associated with at least one database 110. Note, however, that other combinations and arrangements of components may also be used here.

In this example, each user device 102a-102d is coupled to or communicates over the network(s) 104. Communications between each user device 102a-102d and at least one network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The at least one network 104 facilitates communication between various components of the system 100. For example, the network(s) 104 may communicate Internet Protocol (IP) packets, frame relay frames, Asynchronous Transfer Mode (ATM) cells, or other suitable information between network addresses. The network(s) 104 may include one or more local area networks (LANs), metropolitan area networks (MANs), wide area networks (WANs), all or a portion of a global network such as the Internet, or any other communication system or systems at one or more locations. The network(s) 104 may also operate according to any appropriate communication protocol or protocols.

The application server 106 is coupled to the at least one network 104 and is coupled to or otherwise communicates with the database server 108. The application server 106 supports various functions related to managed data services on a cloud platform embodied by at least the application server 106 and the database server 108. For example, the application server 106 may execute one or more applications 112, which can be used to receive requests for creating a managed data service on the cloud platform, create metadata for data clusters stored in and accessible via the at least one database 110 on the database server 108, and receive instructions for configuring a multi-tier database via the at least one database 110 on the database server 108. The one or more applications 112 may also be instructed to deploy data clusters using a cloud formation template, where each data cluster can be created using one or more user accounts that has access to the multi-tier database. The one or more applications 112 may also be instructed to make the data clusters available for receiving and processing requests related to a variety of use cases, and to store timeseries information in the database 110, which can also store the timeseries information in a tick database in various embodiments of this disclosure. The one or more applications 112 may further present one or more graphical user interfaces to users of the user devices 102a-102d, such as one or more graphical user interfaces that allow a user to retrieve and view timeseries information and initiate one or more analyses of the timeseries information, and display results of the one or more analyses. The application server 106 can interact with the database server 108 in order to store information in and retrieve information from the database 110 as needed or desired. Additional details regarding example functionalities of the application server 106 are provided below.

The database server 108 operates to store and facilitate retrieval of various information used, generated, or collected by the application server 106 and the user devices 102a-102d in the database 110. For example, the database server 108 may store various types of timeseries related information, such as information used in statistics, signal processing, pattern recognition, econometrics, mathematical finance, weather forecasting, earthquake prediction, electroencephalography, control engineering, astronomy, communications engineering, and largely in any domain of applied science and engineering which involves temporal measurements, such as information including annual sales data, monthly subscriber numbers for various services, stock prices, Internet of Things (IoT) device data and/or statuses, such as data related to various measured metrics like temperature, rainfall, heartbeats per minute, etc., stored in the database 110. Note, however, that the database server 108 may be used within the application server 106 to store information in other embodiments, in which case the application server 106 may store the information itself.

Some embodiments of the system 100 allow for information to be harvested or otherwise obtained from one or more external data sources 114 and pulled into the system 100, such as for storage in the database 110 and use by the application server 106. Each external data source 114 represents any suitable source of information that is useful for performing one or more analyses or other functions of the system 100. At least some of this information may be stored in the database 110 and used by the application server 106 to perform one or more analyses or other functions using the data stored in the database 110 such as timeseries data. Depending on the circumstances, the one or more external data sources 114 may be coupled directly to the network(s) 104 or coupled indirectly to the network(s) 104 via one or more other networks.

In some embodiments, the functionalities of the application server 106, the database server 108, and the database 110 may be provided in a cloud computing environment, such as by using a proprietary cloud platform or by using a hosted environment such as the AMAZON WEB SERVICES (AWS) platform, the GOOGLE CLOUD platform, or MICROSOFT AZURE. In these types of embodiments, the described functionalities of the application server 106, the database server 108, and the database 110 may be implemented using a native cloud architecture, such as one supporting a web-based interface or other suitable interface. Among other things, this type of approach drives scalability and cost efficiencies while ensuring increased or maximum uptime. This type of approach can allow the user devices 102a-102d of one or multiple organizations (such as one or more companies) to access and use the functionalities described in this patent document. However, different organizations may have access to different data or other differing resources or functionalities in the system 100.

In some cases, this architecture uses an architecture stack that supports the use of internal tools or datasets (meaning tools or datasets of the organization accessing and using the described functionalities) and third-party tools or datasets (meaning tools or datasets provided by one or more parties who are not using the described functionalities). Datasets used in the system 100 can have well-defined models and controls in order to enable effective importation and use of the datasets, and the architecture may gather structured and unstructured data from one or more internal or third-party systems, thereby standardizing and joining the data source(s) with the cloud-native data store. Using a modern cloud-based and industry-standard technology stack can enable the smooth deployment and improved scalability of the described infrastructure. This can make the described infrastructure more resilient, achieve improved performance, and decrease the time between new feature releases while accelerating research and development efforts.

Among other possible use cases, a native cloud-based architecture or other architecture designed in accordance with this disclosure can be used to leverage data such as timeseries data with advanced data analytics in order to make investing processes more reliable and reduce uncertainty. In these types of architectures, the described functionalities can be used to obtain various technical benefits or advantages depending on the implementation. For example, these approaches can be used to drive intelligence in investing processes or other processes by providing users and teams with information that can only be accessed through the application of data science and advanced analytics. Based on the described functionalities, the approaches in this disclosure can meaningfully increase sophistication for functions such as selecting markets and analyzing transactions.

The value or benefits of data science and advanced analytics driven by the described approaches can be highly useful or desirable. For example, deal sourcing can be driven by deeply understanding the drivers of market performance in order to identify high-quality assets early in their lifecycles to increase or maximize investment returns. This can also position institutional or corporate investors to initiate outbound sourcing efforts in order to drive proactive partnerships with operating partners. Moreover, with respect to transaction analysis during diligence and execution phases of transactions, this can help optimize deal tactics by providing precision and clarity to underlying market fundamentals.

Although FIG. 1 illustrates one example of a system 100 supporting managed data services on cloud platforms, various changes may be made to FIG. 1. For example, the system 100 may include any number of user devices 102a-102d, networks 104, application servers 106, database servers 108, databases 110, applications 112, and external data sources 114. Also, these components may be located in any suitable locations and might be distributed over a large area. In addition, while FIG. 1 illustrates one example operational environment in which managed data services on cloud platforms may be used, this functionality may be used in any other suitable system.

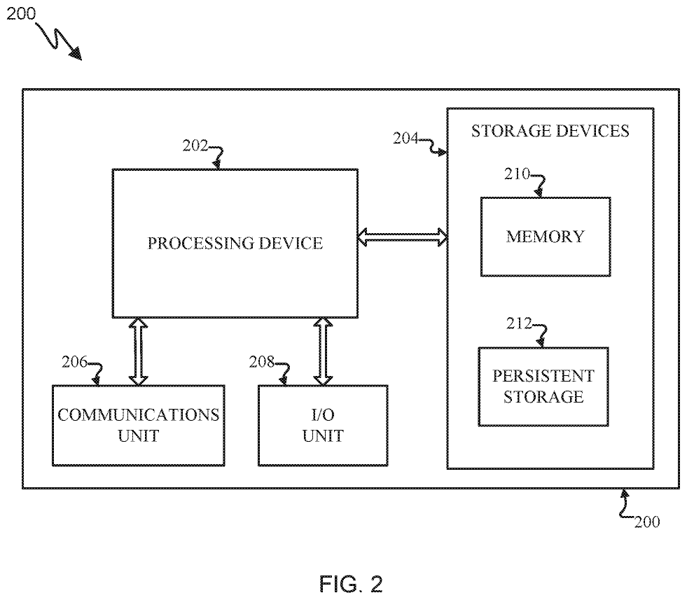

FIG. 2 illustrates an example device 200 supporting managed data services on cloud platforms in accordance with this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc. In some embodiments, the persistent storage 212 can include one or more components or devices supporting faster data access times such as at least one solid state drive (SSD), as well as one or more cost-effective components or devices for storing older or less-accessed data such as at least one traditional electro-mechanical hard drive. The device 200 can also access data stored in external memory storage locations the device 200 is in communication with, such as one or more online storage servers.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the application server 106. Thus, for example, the instructions executed by the processing device 202 may cause the device 200 to perform various functions related to managed data services on a cloud platform, such as for storing, retrieving, and analyzing timeseries data used in various industries. As particular examples, the instructions may cause the device 200 to receive or transmit requests for creating a managed data service on the cloud platform, create metadata for data clusters stored in and accessible via the at least one database 110 on the database server 108, and receive or transmit instructions for configuring a multi-tier database. The instructions may also cause the device 200 to cause the deployment of data clusters using a cloud formation template, where each data cluster can be created using one or more user accounts that has access to the multi-tier database. The instructions may also cause the device 200 to make the data clusters available for receiving and processing requests related to a variety of use cases, and to store timeseries information in the database, which can also store the timeseries information in a tick database in various embodiments of this disclosure. The instructions may also cause the device 200 to present one or more graphical user interfaces to users of the device 200, or to users of the user devices 102a-102d, such as one or more graphical user interfaces that allow a user to retrieve and view timeseries information and initiate one or more analyses of the timeseries information, and display results of the one or more analyses.

Although FIG. 2 illustrates one example of a device 200 supporting managed data services on cloud platforms, various changes may be made to FIG. 2. For example, computing and communication devices and systems come in a wide variety of configurations, and FIG. 2 does not limit this disclosure to any particular computing or communication device or system.

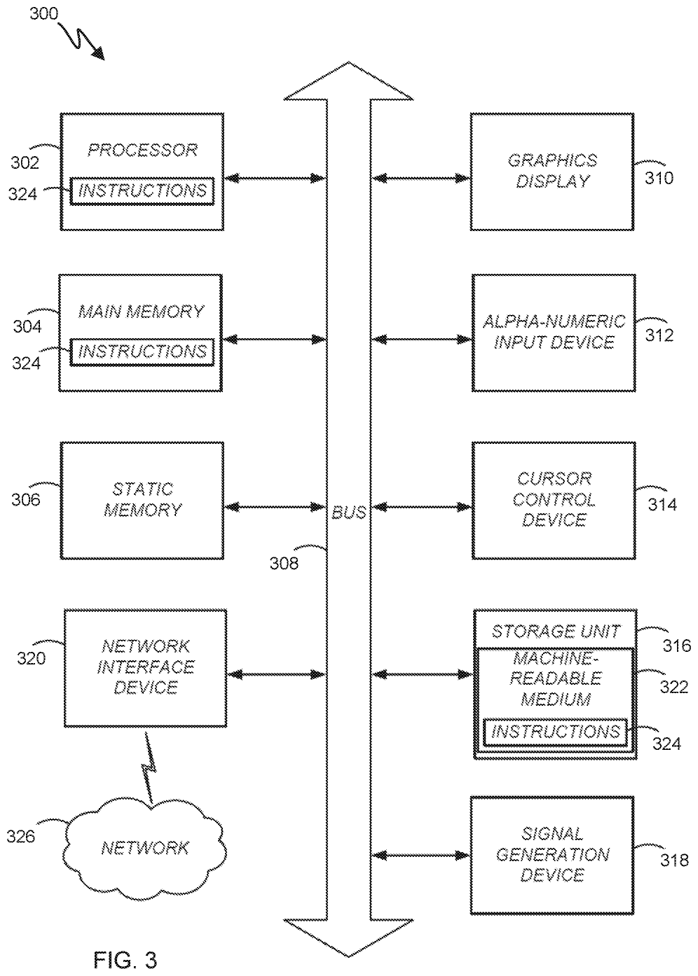

FIG. 3 illustrates an example computer system 300 within which instructions 324 (such as software) for causing an electronic device to perform any one or more of the methodologies discussed herein may be executed. One or more instances of the system 300 may, for example, be used to at least partially implement the functionality of the application server 106 of FIG. 1. However, the functionality of the application server 106 may be implemented in any other suitable manner. In some embodiments, the system 300 shown in FIG. 3 may form at least part of a user device 102a-102d, application server 106, or database server 108 in FIG. 1. However, each of these components may be implemented in any other suitable manner. In alternative embodiments, the system 300 operates as a standalone device or may be connected (such as networked) to other electronic devices. In a networked deployment, the system 300 may operate in the capacity of a server electronic device or a client electronic device in a server-client network environment, or as a peer electronic device in a peer-to-peer (or distributed) network environment.

The system 300 may be at least part of a server computer, a client computer, a personal computer (PC), a tablet PC, a set-top box (STB), a personal digital assistant (PDA), a cellular telephone, a smartphone, a web appliance, a network router, switch or bridge, or any electronic device capable of executing instructions 324 (sequential or otherwise) that specify actions to be taken by that electronic device. Further, while only a single system is illustrated, the term “system” shall also be taken to include any collection of electronic devices that individually or jointly execute instructions 324 to perform any one or more of the methodologies discussed herein.

The example computer system 300 includes a processor 302 (such as a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include graphics display unit 310 (such as a plasma display panel (PDP), a liquid crystal display (LCD), a projector, or a cathode ray tube (CRT)). The computer system 300 may also include alphanumeric input device 312 (such as a keyboard), a cursor control device 314 (such as a mouse, a trackball, a joystick, a motion sensor, or other pointing instrument), a storage unit 316, a signal generation device 318 (such as a speaker), and a network interface device 320, which also are configured to communicate via the bus 308.

The storage unit 316 includes a machine-readable medium 322 on which is stored instructions 324 (such as software) embodying any one or more of the methodologies or functions described herein. The instructions 324 may also reside, completely or at least partially, within the main memory 304 or within the processor 302 (such as within a processor's cache memory) during execution thereof by the computer system 300, the main memory 304 and the processor 302 also constituting machine-readable media. The instructions 324 may be transmitted or received over a network 326 via the network interface device 320.

While machine-readable medium 322 is shown in an example embodiment to be a single medium, the term “machine-readable medium” should be taken to include a single medium or multiple media (such as a centralized or distributed database, or associated caches and servers) able to store instructions (such as instructions 324). The term “machine-readable medium” shall also be taken to include any medium that is capable of storing instructions (such as instructions 324) for execution by the machine and that cause the machine to perform any one or more of the methodologies disclosed herein. The term “machine-readable medium” includes, but not be limited to, data repositories in the form of solid-state memories, optical media, and magnetic media.

Although FIG. 3 illustrates one example of a computer system 300, various changes may be made to FIG. 3. For example, various components and functions in FIG. 3 may be combined, further subdivided, replicated, or rearranged according to particular needs. Also, one or more additional components and functions may be included if needed or desired. Computing and communication devices and systems come in a wide variety of configurations, and FIG. 3 does not limit this disclosure to any particular computing or communication device or system.

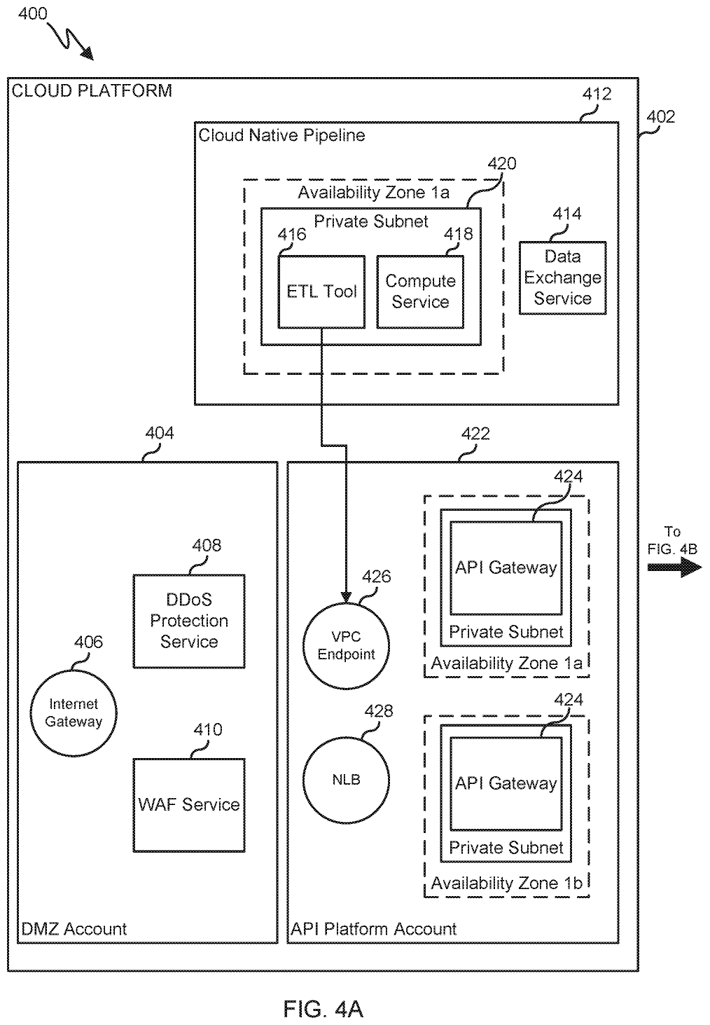

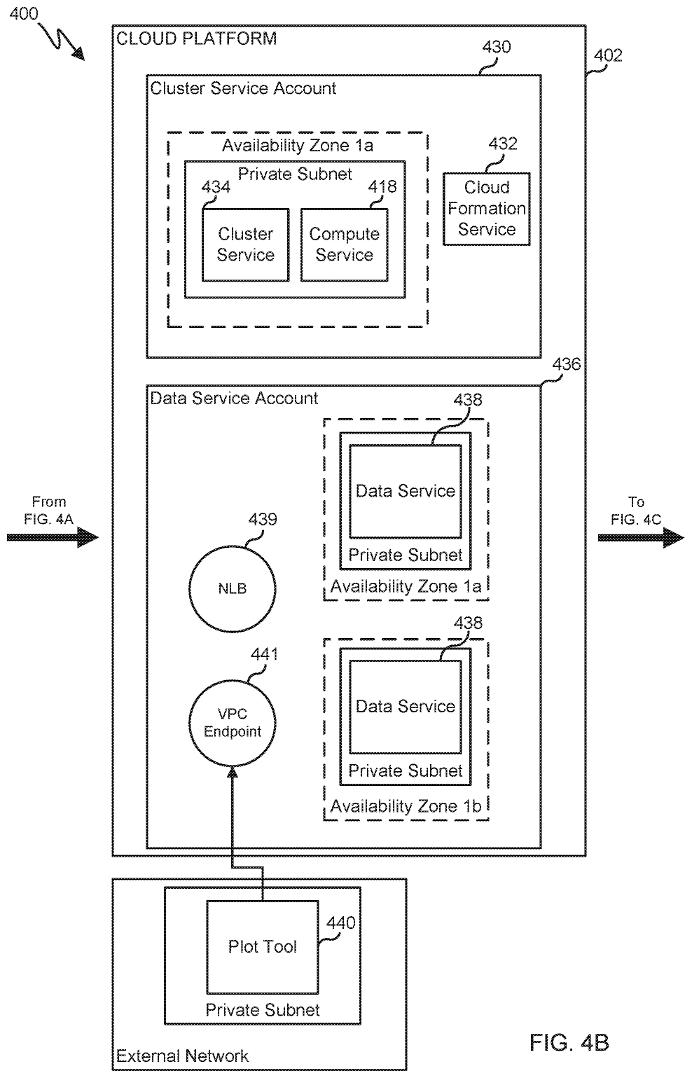

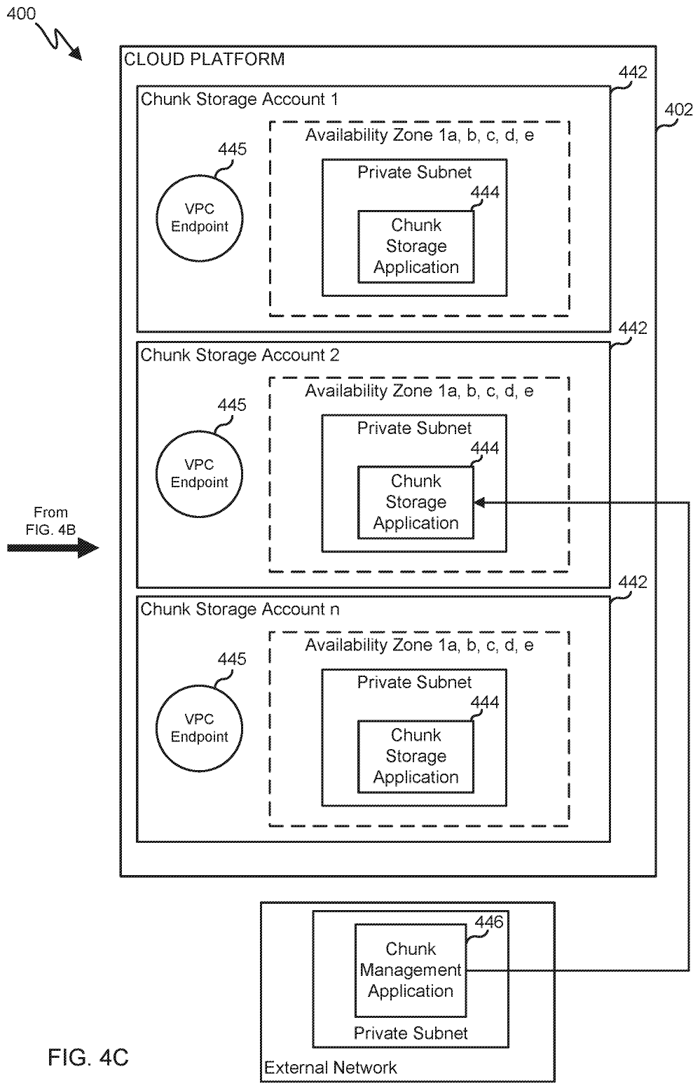

FIGS. 4A through 4C illustrate an example functional architecture 400 for managed data services on cloud platforms in accordance with this disclosure. For ease of explanation, the functional architecture 400 of FIGS. 4A through 4C may be implemented using or provided by one or more applications 112 executed by the application server 106 of FIG. 1, and/or the database server 108, where the application server 106 and the database server 108 may be implemented using one or more devices 200 of FIG. 2. However, the functional architecture 400 may be implemented using or provided by any other suitable device(s) and in any other suitable system(s).

The architecture 400 includes a cloud platform 402 that can be made up of various electronic devices such as one or more application servers, such as the application server 106, one or more database servers, such as the database server 108, and/or any other electronic devices as needed for initiating and executing the various logical components of the cloud platform 402 shown in FIGS. 4A through 4C.

In some embodiments, as shown in FIG. 4A, the cloud platform 402 can include a demilitarized zone (DMZ) account 404 that functions as a subnetwork that includes exposed, outward-facing services, acting as the exposed point to untrusted networks, such as the Internet, and thus can include an Internet Gateway 406. The DMZ account 404 provides an extra layer of security for the cloud platform 402, and can include various security processes. For example, the DMZ account 404 can include a distributed denial of service (DDoS) protection service 408 to safeguard applications running on the cloud platform. As another example, the DMZ account 404 can include a web application firewall (WAF) service 410 that protects applications executed on the cloud platform 402 against various malicious actions, such as exploits that can consume resources or cause downtime for the cloud platform 402.

The cloud platform 402 can also include at least one cloud native pipeline 412, which can perform various functions configured or built to run in the cloud and are integrated into one or more shared repositories for building and/or testing each change automatically. As one example, the cloud native pipeline 412 can include a data exchange service 414 that can locate and access various data from internal or external data sources, such as data files, data tables, data application programming interfaces (APIs), etc. The data exchange service 414 allows for seamless sourcing of new data feeds for use in the data analysis processes described herein. The cloud native pipeline 412 can also include an extract, transform, load (ETL) tool 416, which can be configured to extract or collect data from the various data sources, transform the data to be in a format for use by certain applications, and load the transformed data back into a centralized data storage location. In some embodiments, the ETL tool 416 can combine or integrate data received from different ones of the various sources together prior to providing the data to other processes. The ETL tool 416 can also provide the data to other components of the cloud platform 402, such as an API platform account 422, as shown in FIG. 4A. In various embodiments, the cloud native pipelines 412 can also include a compute service 418 that can run various code or programs in a serverless manner, that is, without provisioning or managing servers, such as by triggering cloud platform step functions. The compute service 418 can run code on a high-availability compute infrastructure to perform administration of computing resources, including server and operating system maintenance, capacity provisioning and automatic scaling, and logging processes. In some embodiments, the ETL tool 416 and the compute service 418 can be executed within an instance of a private subnet associated with the cloud native pipeline 412 to provide increased separation of the processes from other networks such as the Internet, as using a private subnet can avoid accepting incoming traffic from the Internet, and thus can also avoid using public Internet Protocol (IP) addresses.

The API platform account 422, as shown in FIG. 4A, includes one or more API gateways 424 that can be configured to provide applications access to various data, logic, or functionality. Each API gateway 424 can be executed on a private subnet in some embodiments. The API platform account 422 can receive various data from the ETL tool 416, which can be received via a virtual private cloud (VPC) endpoint 426. VPC endpoints as described in this disclosure can enable private connections between various connected or networked physical or logical components to provide for secure exchange of data between the components. In some embodiments, the API platform account 422 can also include a network load balancer (NLB) 428 that is used to automatically distribute and balance incoming traffic across multiple targets such as multiple API gateways 424.

As shown in FIG. 4B, the cloud platform 402 also includes a cluster service account 430 that can include a cloud formation service 432 and a cluster service 434. The cloud formation service 432 can be configured to receive information in a standardized format concerning how the cloud infrastructure should be deployed, such as setting up user accounts, deploying data clusters associated with the user accounts, setting up data storage paradigms such as the multi-tier database configuration for timeseries information described in this disclosure, etc. The cloud formation service 432 can accept infrastructure configuration details in one or more cloud formation templates that defines various parameters such as the number of data clusters, the database configuration, the database(s) the clusters have access to, etc. A cluster service 434 oversees the creation and management of data clusters such as defined in the cloud formation template. In some embodiments, a compute service 418, which can be the same or a different compute service than that shown in FIG. 4A, can be triggered, such as by the cluster service 434, to both create metadata for one or more clusters in the database(s), as well as trigger a function to initiate account creation.

The cloud platform 402 also includes a data service account 436 that can be associated with one or more users or devices. The data service account 436 includes at least one data service 438. In some embodiments, each data service 438 can be executed in a private subnet. In some embodiments, the data service account 436 can also include an NLB 439 for managing traffic and resource allocation for functions provided by the data service(s) 438. The data service 438 can be an application that retrieves data, such as timeseries data from the cloud database(s), and provides that data to one or more other applications for reporting and analysis. For example, as shown in FIG. 4B, a plot tool 440 can connect to the data service account 436 and the data service(s) 438 can provide requested data to the plot tool 440. In some embodiments, the plot tool 440 can communicate with the data service account 436 and its associated data services 438 via a VPC endpoint 441. In some embodiments, the plot tool 440 can be executed on a private subnet. The plot tool 440 can also be executed in a network external to the cloud platform 402, and can be executed on an electronic device, such as one of the user devices 102a-102d. In various embodiments, the plot tool 440 is a data analytics program or software that receives timeseries data in real-time from the cloud platform 402 to perform various timeseries analytics, such as charting changes in timeseries data over time, performing data analysis functions on the data such as a mean function or a correlation function, measuring asset volatility, etc.

As shown in FIG. 4C, the cloud platform 402 also includes a plurality of chunk storage accounts 442. Each chunk storage account 442 can be associated with one or more users or user devices, and can provide for the receipt and storage of data across various domains and industries into serialized data stored in user defined chunks in one or more databases using an instance of a chunk storage application 444. In some embodiments, each chunk storage application 444 can be executed on a private subnet. The architecture 400 also includes a chunk management application 446 which can be executed on an external network and on its own private subnet. The chunk management application 446 can be configured to communicate with the server-side chunk storage application 444 associated with the same account to send instructions the chunk storage application 444 to set up data clusters for storing chunks, provide data to be stored in the databases by the chunk storage application 444, etc.

As shown in FIGS. 4A thorough 4C, various components or functions of the architecture 400 can be executed using availability zones. For example, as shown in FIGS. 4A through 4C, the ETL tool 416, the compute service(s) 418, instances of the API gateway 424, the cluster service 434, instances of the data service 438, and instances of the chunk storage application 444 can be executed in the same or different availability zones as desired. The different availability zones can each be associated with a geographical region, and provide for application isolation and failover. For example, if there is a power loss in one of the availability zones, services can continue to run in the other availability zones. The use of availability zones can therefore significantly help with resiliency with respect to providing real-time data reporting and analysis.

Although FIGS. 4A through 4C illustrate one example of a functional architecture 400 for managed data services on cloud platforms, various changes may be made to FIGS. 4A through 4C. For example, various components and functions in FIGS. 4A through 4C may be combined, further subdivided, replicated, or rearranged according to particular needs. Also, one or more additional components and functions may be included if needed or desired. Computing architectures and systems come in a wide variety of configurations, and FIGS. 4A through 4C do not limit this disclosure to any particular computing architecture or system. For instance, the components of the architecture 400 illustrated in FIGS. 4A through 4B could be proprietary server processes or provided by a hosted cloud computing environment, such as AWS platform, GOOGLE CLOUD platform, or MICROSOFT AZURE platform. Additionally, the functional architecture 400 can be used to perform any desired data gathering, storing, reporting, and associated analyses, such as timeseries data gathering and analyses, and the numbers and types of analyses that are currently used can expand or contract based on changing analysis requirements or other factors. While certain examples of these analyses are described above and below, these analyses are for illustration and explanation only.

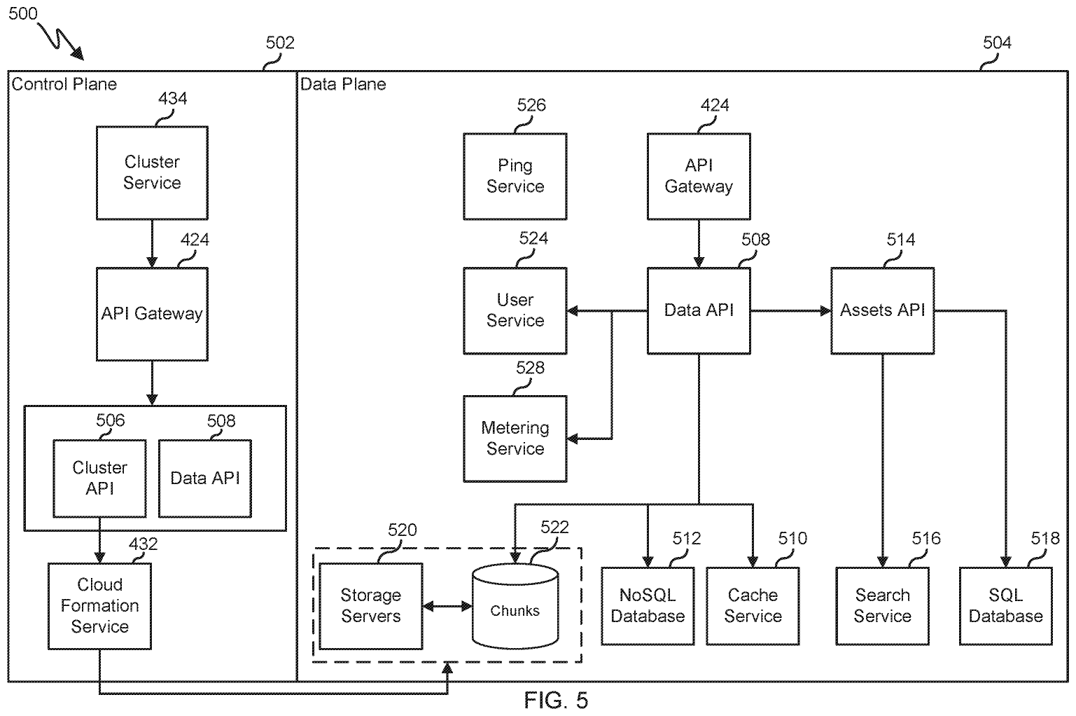

FIG. 5 illustrates an example logically-divided architecture 500 for managed data services on cloud platforms in accordance with this disclosure. For ease of explanation, the architecture 500 of FIG. 5 may be implemented using or provided by one or more applications 112 executed by the application server 106 of FIG. 1, and/or the database server 108, where the application server 106 and the database server 108 may be implemented using one or more devices 200 of FIG. 2. In some embodiments, the architecture 500 is at least part of the architecture 400. However, the architecture 500 may be implemented using or provided by any other suitable device(s) and in any other suitable system(s).

The architecture 500 as illustrated in FIG. 5 is separated logically into a control plane 502 and a data plane 504. The control plane 502 includes various functions related to controlling cloud architecture formation and controlling data service requests. For example, the control plane 502 includes the cluster service 434. The cluster service 434, as described in various embodiments of this disclosure, can set up data clusters based on cloud formation templates, set up storage location and database configurations based on cloud formation templates, process requests for data and serve data from various data storage locations in real time, etc. For instance, the cluster service 434 can access the API gateway 424 to interact with, for example, a cluster API 506 and/or a data API 508. In various embodiments, the cluster API 506 can be used to provide data cluster formation requests and/or database formation requests to the cloud formation service 432 to establish data clusters or establish database structures for the handling and storing of data such as timeseries data to be used for performing real-time data analysis.

The data plane 504 includes various data related services. For example, the API gateway 424 can provide access to the data API 508, such as based on a request first received by the cluster service 434. The data API 508 can provide various functions such as receiving new data to store in various data storage locations, continuously retrieving data in real-time and transmitting the real-time data to analytics tools, such as the plot tool 440, etc. In embodiments of this disclosure, the data API 508 can access various data storage locations based on a multi-tiered database structure. For example, the data API 508 can access cached, first-tier, data using a cache service 510. The caching service 510 can be supported by a NoSQL database 512. The NoSQL database 512 can be a fully managed, serverless, key-value NoSQL database that supports built-in security, continuous backups, automated multi-region replication, in-memory caching, and data export tools. However, other embodiments can use other types of databases, such as a SQL database, that support the features used by the NoSQL database 512. The cache service 510 can retrieve data items using the NoSQL database 512 and store the data in fast cache memory (such as RAM).

The data API 508 can also retrieve data items stored in a second tier set of memory, such as on-device SSD memory. To retrieve data using second tier databases, in some embodiments, the data API 508 uses an assets API 514 that performs asset searching and retrieval using a search service 516 and a SQL database 518. For instance, the data API 508 can request via the assets API 514 the retrieval of certain assets, such as assets from a particular time period, or assets defined by a particular asset reference. The assets API 514 can then use the search service 516 to search the SQL database 518 for the storage location of the second-tier data asset, retrieve the asset, and return the asset in response to the request, such as by transmitting the asset and/or its relevant data to a data analytics application such as the plot tool 440. As another example, the data API 508 can also access third-tier databases and data stored using slower memory devices on off-device storage servers 520. In various embodiments of this disclosure, data can be stored as data objects or chunks stored in chunk storage database 522. Data chunks and/or data contained within data chunks can be stored at any of the data tiers based on, for example, a timestamp associated with the data chunk. It will be understood that, in various embodiments of this disclosure, data can be retrieved from first-tier, second-tier, and third-tier databases and storage locations substantially simultaneously to allow for data analysis using data from various time periods. In some embodiments, the data plane 504 can include other processes such as a user service 524 configured to manage user accounts, a ping service 528 configured to measure server latencies, and a metering service 528 configured to track server data usage by client devices to facilitate various processes based on data use such as client invoicing.

Although FIG. 5 illustrates one example of a logically-divided architecture 500 for managed data services on cloud platforms, various changes may be made to FIG. 5. For example, various components and functions in FIG. 5 may be combined, further subdivided, replicated, or rearranged according to particular needs. Also, one or more additional components and functions may be included if needed or desired. Computing architectures and systems come in a wide variety of configurations, and FIG. 5 does not limit this disclosure to any particular computing architecture or system.

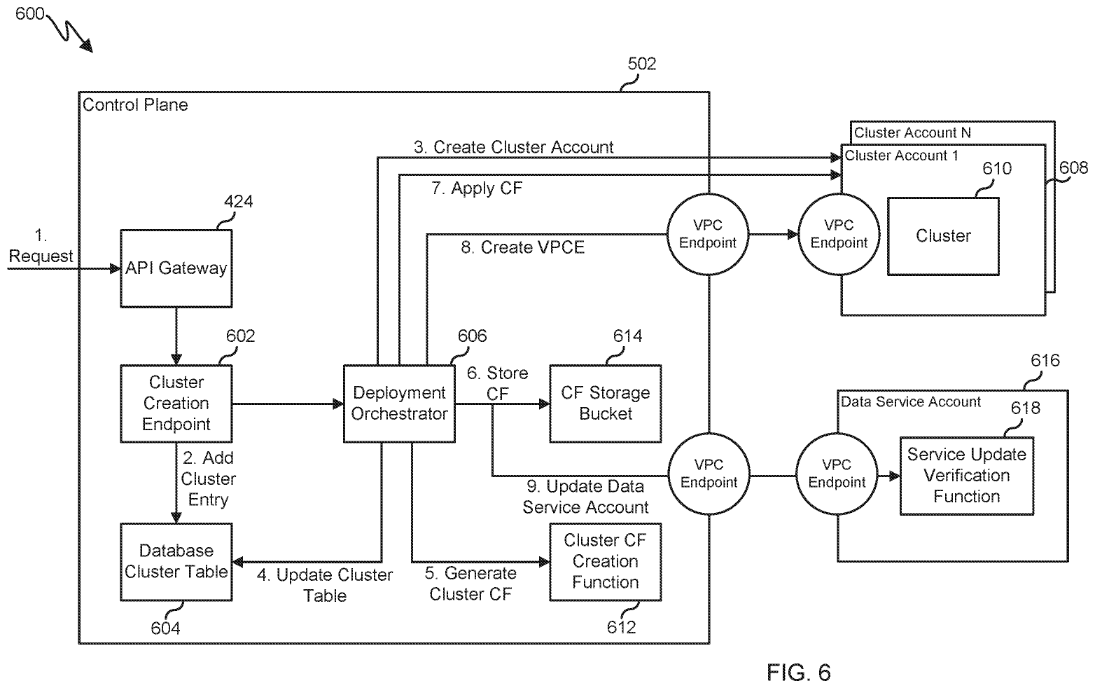

FIG. 6 illustrates an example cluster creation process 600 in accordance with embodiments of this disclosure. For ease of explanation, the process 600 is described as involving the use of the one or more applications 112 executed by the application server 106 of FIG. 1, and/or the database server 108, where the application server 106 and the database server 108 may be implemented using one or more devices 200 of FIG. 2. However, the process 600 may be performed using any other suitable device(s) and in any other suitable system(s).

As shown in FIG. 6, at a first step, the API gateway 424 within the control plane 502 receives a request to create one or more new clusters, such as a request transmitted to the API gateway using one of the user devices 102a-102d. At a second step, a cluster creation endpoint 602 is used to add a cluster entry to a database cluster table 604. In some embodiments, the cluster creation endpoint 602 can be the cluster service 434. In some embodiments, the database cluster table 604 can be the NoSQL database 512, the SQL database 518, or another type of database.

At a third step, a deployment orchestrator 606 creates or updates a cluster account 608 using the cluster information. In some embodiments, the deployment orchestrator 606 can be the cloud formation service 432. The cluster account 608 can execute in association therewith a cluster 610 for performing various data operations and functions as described in this disclosure. In this way, each data cluster associated with a user or user device is deployed using a cloud formation template into a separate and isolated VPC account. This provides the benefits of an isolated runtime for each deployment, which ensures both security and reduced chance of any noisy neighbor impact, that is, it reduces the likelihood that other processes for other accounts will monopolize bandwidth. At a fourth step, the deployment orchestrator 606 updates the database cluster table to reflect the newly created cluster information.

At a fifth step, the deployment orchestrator 606 generates a cluster cloud formation (CF) using a cluster CF creation function 612. In various embodiments, the cluster CF can include various parameters related to the resources to be provisioned for the new cluster account, such as the number of data clusters, the database configuration, the database(s) the clusters have access to, etc. The cluster CF can be created based on a pre-set template originally created by a client devices such as one of the user devices 102a-102d and stored for reference by the cloud platform, or parameters for the CF can be included in the request transmitted at the first step of FIG. 6. At a sixth step, the deployment orchestrator 606 stores the cluster CF in a CF storage bucket 614 maintained by the cloud server platform. At a seventh step, the deployment orchestrator 606 applies the CF to the cluster account 608.

At an eighth step, the deployment orchestrator 606 creates a VPC endpoint to enable secure communication between the cluster(s) 610 and other components of the server platform. At a ninth step, the deployment orchestrator 606 updates a data service account 616 using a service update verification function 618. In some embodiments, the data service account 616 can be the data service account 436 and can be associated with a user account and/or cluster account to execute data service(s) 438 for the associated accounts to retrieve data, such as timeseries data from the cloud database(s), provide that data to one or more other applications for reporting and analysis, meter data usage in association with a user account, etc. In some embodiments, the data service account 616 and its associated functions or programs can communicate with other cloud server components via an established VPC endpoint, as illustrated in FIG. 6. The process 600 allows for the creation of cluster provisioning and database setup to provide rapid deployment of systems and timeseries information and analysis, reducing system setup time from weeks to just minutes. This increases velocity by allowing new markets to be entered or additional analysis operations to be performed quickly.

Although FIG. 6 illustrates one example of a cluster creation process 600, various changes may be made to FIG. 6. For example, various components and functions in FIG. 6 may be combined, further subdivided, replicated, or rearranged according to particular needs. Also, one or more additional components and functions may be included if needed or desired. Computing systems and processes come in a wide variety of configurations, and FIG. 6 does not limit this disclosure to any particular computing system or process.

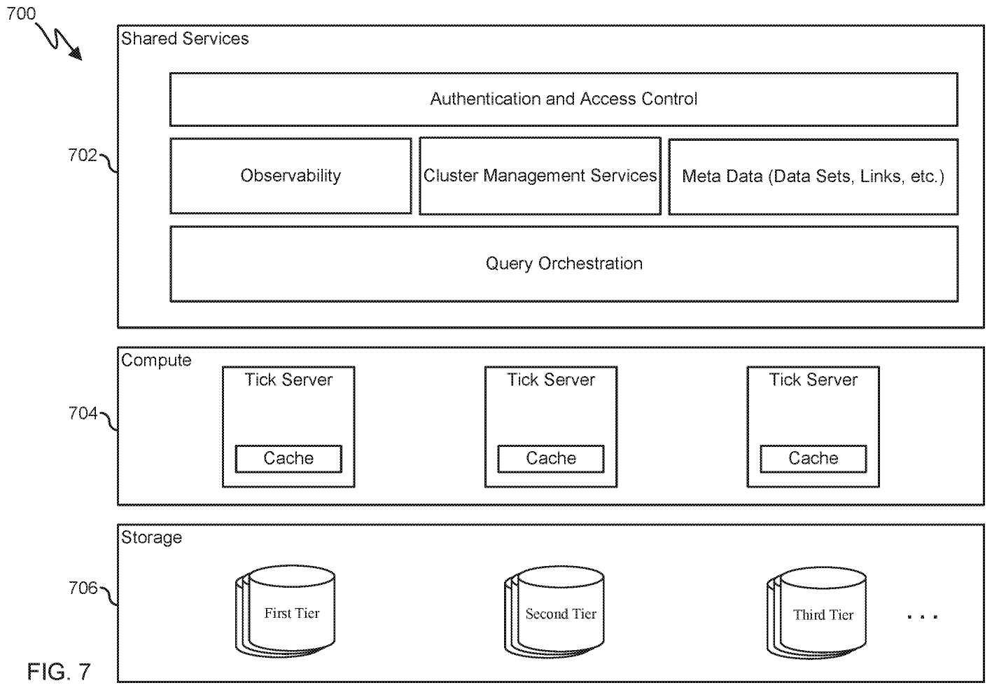

FIG. 7 illustrates an example high-level managed services architecture 700 in accordance with this disclosure. For ease of explanation, the architecture 700 of FIG. 7 may be implemented using or provided by one or more applications 112 executed by the application server 106 of FIG. 1, and/or the database server 108, where the application server 106 and the database server 108 may be implemented using one or more devices 200 of FIG. 2. In some embodiments, the architecture 700 is at least part of the architecture 400. However, the architecture 700 may be implemented using or provided by any other suitable device(s) and in any other suitable system(s).

As shown in FIG. 7, the architecture 700 can include shared services 702. The shared services 702 can be accessed by and shared by a plurality of user accounts and user resources, such as clusters associated with different user accounts. The shared services 702 can include authentication and access control services, observability services, cluster management services, metadata services such as access to data sets, links, etc., and query orchestration services. In some embodiments, the shared services 702 can include the ability to share data between users/entities. For example, data feeds, such as data stored at one of the data tiers, such as three data tiers, stored in tick servers, etc., that were originally supplied by one user or entity can be designated as shared to enable access to the data by other users or entities, allowing for extended accumulation of data among various sectors to be used for analysis. The architecture 700 also includes compute services 704 that can include, among other things, tick servers that use cached timeseries data to provide real-time data updates for analysis. The architecture 706 also includes storage services that include the multiple storage tiers described in this disclosure.

Although FIG. 7 illustrates one example of a high-level managed services architecture 700, various changes may be made to FIG. 7. For example, various components and functions in FIG. 7 may be combined, further subdivided, replicated, or rearranged according to particular needs. Also, one or more additional components and functions may be included if needed or desired. Computing architectures and systems come in a wide variety of configurations, and FIG. 7 does not limit this disclosure to any particular computing architecture or system.

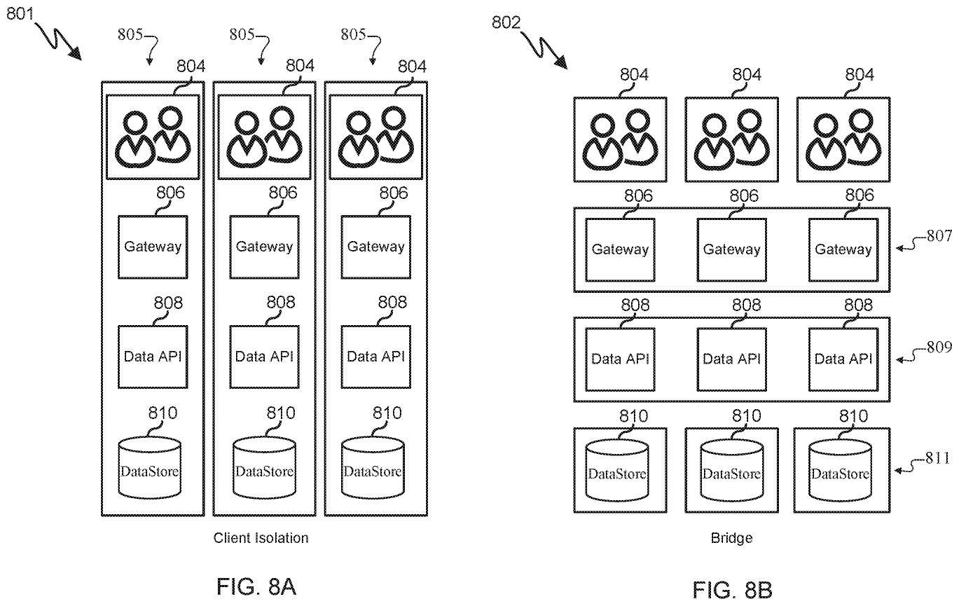

FIGS. 8A and 8B illustrate example managed services paradigms 801 and 802 in accordance with this disclosure. For ease of explanation, the paradigms 801 and 802 of FIGS. 8A and 8B may be implemented using or provided by one or more applications 112 executed by the application server 106 of FIG. 1, and/or the database server 108, where the application server 106 and the database server 108 may be implemented using one or more devices 200 of FIG. 2. In some embodiments, the paradigms 801 and 802 can be implemented as at least part of the architecture 400. However, the paradigms 801 and 802 may be implemented using or provided by any other suitable device(s) and in any other suitable system(s).

As shown in FIG. 8A, a first managed services paradigm 801 can be established to isolate one or more clients 804 (such as individual users, devices, entities, and/or accounts) from each other. For example, clients can be isolated into separate, walled-off, cloud formations 805, where each cloud formation 805 has one client 804 that can access a datastore 810 associated with the one client 804 using a separate gateway 806 and separate data API 808. In some embodiments of this disclosure, the first managed services paradigm 801 can be established to prevent data sharing between clients 804 for various reasons, such as if the clients 804 are in different industries that would not share data, or if the clients are competitors that do not wish to share data.

As shown in FIG. 8B, a second managed services paradigm 802 can be established to bridge data accessible to the one or more clients 804. For example, in paradigm 802, a plurality of clients 804 can access a same group 807 of gateways 806 (or one shared gateway) and a same group 809 of data APIs 808 (or one shared API) to access a group 811 of datastores 810. Thus, although the datastores 810 may be maintained and populated by separate clients 804, the group 811 of datastores 810 could be accessed by any of the plurality of clients 804 using the gateways 806 and data APIs 808. In some instances, one client may allow its raw data or its data analysis to be shared with many secondary clients, but those secondary clients may not allow sharing with the other secondary clients. In some embodiments of this disclosure, the second managed services paradigm 802 can be established to allow for data sharing between clients 804 for various reasons, such as if the clients 804 are affiliated organizations, if one client offers to provide its data to other clients for a fee, and/or if one or more clients is tasked with sourcing data for the other clients.

For example, in some embodiments, a user or organization can provide via the systems and architectures of this disclosure, a centralized catalog of data sources or feeds that can be made available programmatically or via a user interface. For instance, a user interface populated with different available data sources could be provided, and users could select any of the data feeds to cause the system to access the shared data APIs and import the shared data feed in a matter of seconds. In some embodiments, auto-generated code snippets appearing on each dataset can be copied directly into other user applications to access the data feeds. This allows for data feeds to be accessed through a single API, irrespective of database location.

Although FIGS. 8A and 8B illustrate example managed services paradigms 801 and 802, various changes may be made to FIGS. 8A and 8B. For example, various components and functions in FIGS. 8A and 8B may be combined, further subdivided, replicated, or rearranged according to particular needs. Also, one or more additional components and functions may be included if needed or desired. Computing architectures and systems come in a wide variety of configurations, and FIGS. 8A and 8B do not limit this disclosure to any particular computing architecture or system.

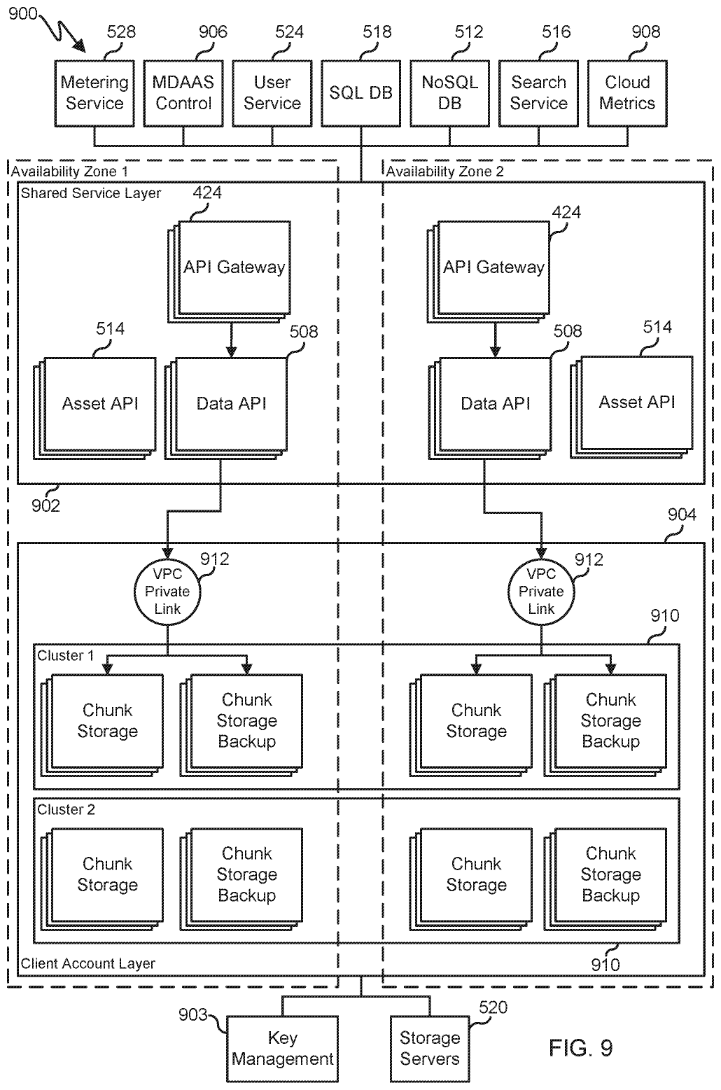

FIG. 9 illustrates an example shared services architecture 900 in accordance with this disclosure. For ease of explanation, the architecture 900 of FIG. 9 may be implemented using or provided by one or more applications 112 executed by the application server 106 of FIG. 1, and/or the database server 108, where the application server 106 and the database server 108 may be implemented using one or more devices 200 of FIG. 2. In some embodiments, the architecture 900 is at least part of the architecture 400. However, the architecture 900 may be implemented using or provided by any other suitable device(s) and in any other suitable system(s).

The architecture 900 includes a shared services layer 902 and a client account layer 904. In some embodiments, the shared services layer 902 can be a set of services provided by the cloud platform to a plurality of clients or users that facilitate the collection and access of data from various data sources. As described with respect to FIGS. 8A and 8B, the services provided by the shared services layer 902 can be configured to allow clients to share data with other clients. The shared services layer 902 includes one or more API gateways 424, one or more asset APIs 514, and one or more data APIs 508, as described in this disclosure. In various embodiments, the shared services layer 902 also has access to various other components or services such as the NoSQL database 512, the search service 516, the SQL database 518, the user service 524, and the metering service 528. The shared services layer 902 can also include a Master Data-as-a-Service (MDaaS) control service 906 which can provide master data governance parameters for stored data such as rules concerning data cleanse and retainment rules, rules for handling duplicate records, rules for integrating data into data analysis applications, etc. The shared services layer 902 can also use a cloud metrics service 908 to collect and visualize real-time logs, metrics, and event data related to application performance, bandwidth use, resource scaling and optimization, etc. The client account layer 904 can access the storage severs 520. In some embodiments, the client account layer 904 also uses a key management service 903 to manage cryptographic keys used for authenticating access to client accounts.

As also illustrated in FIG. 9, in some embodiments, the one or more API gateways 424, the one or more asset APIs 514, and the one or more data APIs 508 can be executed in separate availability zones to provide for application isolation and failover in the event of loss of service. The one or more data APIs 508 in each of the availability zones can communicate with one or more clusters 910 via VPC private links 912 using the same availability zones. For example, as shown in FIG. 9, instances of the one or more API gateways 424, the one or more asset APIs 514, and the one or more data APIs 508 can be executed in a first availability zone along with instances of both first and second clusters 910, such that each cluster 910 and its associated chunk storage and chunk storage backup can be accessed by the shared services within the first availability zone. Likewise, instances of the one or more API gateways 424, the one or more asset APIs 514, and the one or more data APIs 508 can be executed in a second availability zone along with other instances of both the first and second clusters 910, such that each cluster 910 and its associated chunk storage and chunk storage backup can be accessed by the shared services within the second availability zone.

Although FIG. 9 illustrates one example of a shared services architecture 900, various changes may be made to FIG. 9. For example, various components and functions in FIG. 9 may be combined, further subdivided, replicated, or rearranged according to particular needs. Also, one or more additional components and functions may be included if needed or desired. Computing architectures and systems come in a wide variety of configurations, and FIG. 9 does not limit this disclosure to any particular computing architecture or system.

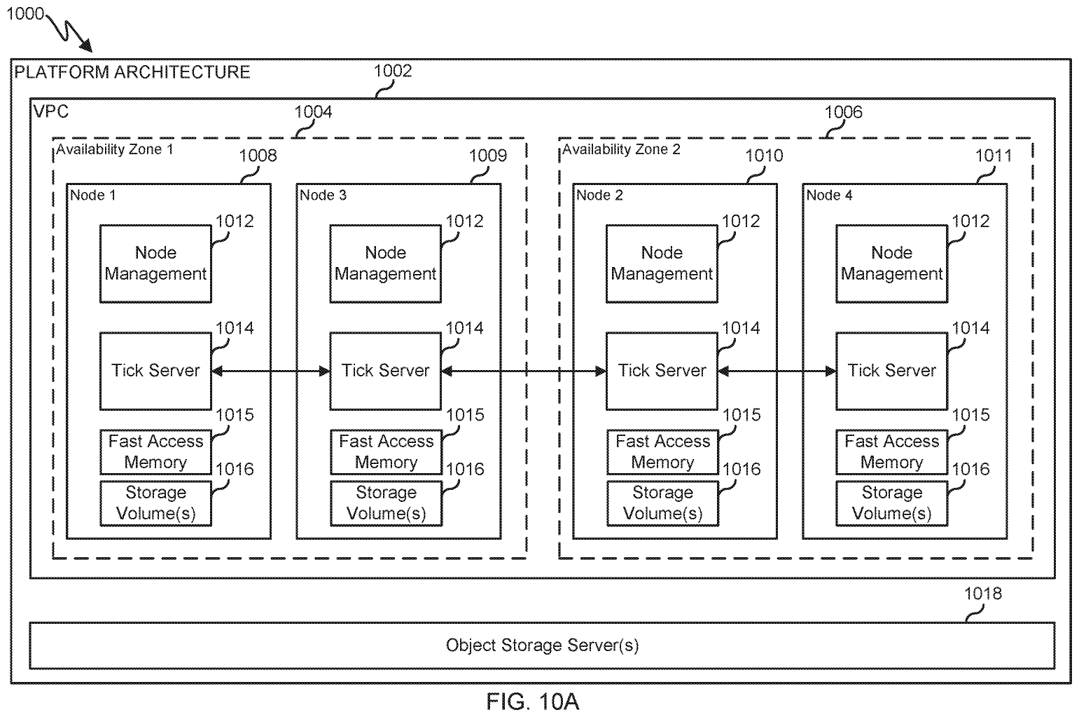

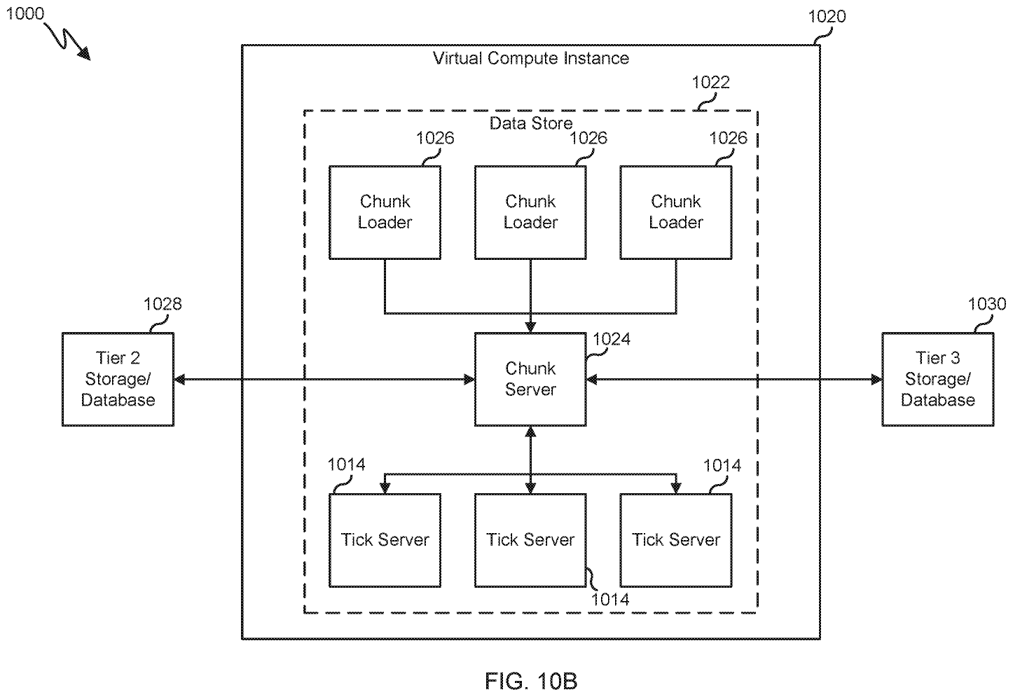

FIGS. 10A and 10B illustrate an example clustering architecture 1000 in accordance with this disclosure. For ease of explanation, the architecture 1000 of FIG. 10 may be implemented using or provided by one or more applications 112 executed by the application server 106 of FIG. 1, and/or the database server 108, where the application server 106 and the database server 108 may be implemented using one or more devices 200 of FIG. 2. In some embodiments, the architecture 1000 is at least part of the architecture 400. However, the architecture 1000 may be implemented using or provided by any other suitable device(s) and in any other suitable system(s).

The architecture 1000 includes a virtual private cloud (VPC) 1002 that can run a plurality of clusters or nodes executing various functions in a plurality of availability zones. For example, as shown in FIG. 10A, the VPC has established a first availability zone 1004 and a second availability zone 1006. Within the first availability zone 1004, a first cluster or node 1008 and a third cluster or node 1009 are executed. Within the second availability zone 1006, a second cluster or node 1010 and a fourth cluster or node 1011 are executed. In various embodiments, each cluster or node 1008-1011 can be initialized to handle specific data sets and/or specific tasks. For instance, the first node 1008 could handle stock price data while the third node 1009 could handle supply chain data. In some embodiments, two or more clusters can be initialized to handle the same data sets and/or tasks, but within different availability zones, to provide application isolation and failover, which significantly increases resiliency in handling live data presentation and analysis. For example, the first node 1008 in the first availability zone and the second node 1010 in the second availability zone 1006 could be initialized to handle the same data and/or tasks so that, if one node fails, the other can immediately take over without any interruption in service to the user.

As also shown in FIG. 10A, each node 1008-1011 includes a node management service 1012. The node management service 1012 manages and orchestrates all processes within its respective node 1008-1011. Each node 1008-1011 also includes a tick server 1014. In various embodiments of this disclosure, a unique and specialized structure is provided for providing timeseries data. Each tick server 1014 can include or be associated with a tick database that stores timeseries information and is optimized for low-latency, real-time, data access to serve real-time data down to nanosecond granularity. Each instance of the tick server 1014 can be linked, or can be the same tick server, as shown in FIG. 10A. Each tick server 1014 receives data from one or more storage locations in a multi-tier database/storage architecture, where the data is stored in one of the different storage location tiers based on certain parameters such as a temporal parameter. As described in embodiments of this disclosure, the specialized structure can be created using one or more cloud formation templates when establishing the data clusters.

For example, most recent timeseries data as defined, for instance, by a timestamp associated with the data, can be stored in, and received by the tick server 1014 from, fast access memory 1015 (such as on-device RAM). Less recent timeseries data can be stored in, and received by the tick server 1014 from, one or more storage volumes 1016 that provide medium access speeds, such as timeseries data stored on SSDs or similar storage devices. Least recent or deep historical timeseries data can be stored in, and received by the tick server 1014 from, slower access solutions such as one or more separate object storage servers 1018. In some embodiments, data stored in each of the fast access memory 1015, the storage volume(s) 1016, and the object storage server(s) 1018 can be managed by separate database systems. The specialized tick server database and multi-tier database architecture provides the benefits of allowing fast server-side processing, while deep history data can be dynamically loaded into memory in order to perform data analysis and calculations using the data.

As shown in FIG. 10B, a virtual compute instance 1020 can run on each of the nodes 1008-1011, and can be managed by the node management service 1012. The virtual compute instance 1020 executes, in a fast data store environment 1022, a chunk server process 1024. The chunk server process 1024 retrieves data from the various storage locations. For example, the chunk server 1024 can retrieve recent timeseries data stored in the fast access memory 1015 using one or more chunk loaders 1026 that provide the data from the fast access memory 1015 to the chunk server 1024. The chunk server 1024 can also retrieved data from tier 2 storage 1028 (such as the storage volume(s) 1016) and from tier 3 storage 1030 (such as the object storage server(s) 1018). The chunk server 1024 provides the retrieved data to one or more instances of the tick server 1014, and the tick server 1014 processes and provides the data, such as to one or more of the user devices 102a-102d executing analysis tools such as the plot tool 440.

Although FIGS. 10A and 10B illustrate one example of a clustering architecture 1000, various changes may be made to FIGS. 10A and 10B. For example, various components and functions in FIGS. 10A and 10B may be combined, further subdivided, replicated, or rearranged according to particular needs. Also, one or more additional components and functions may be included if needed or desired. Computing architectures and systems come in a wide variety of configurations, and FIGS. 10A and 10B do not limit this disclosure to any particular computing architecture or system.

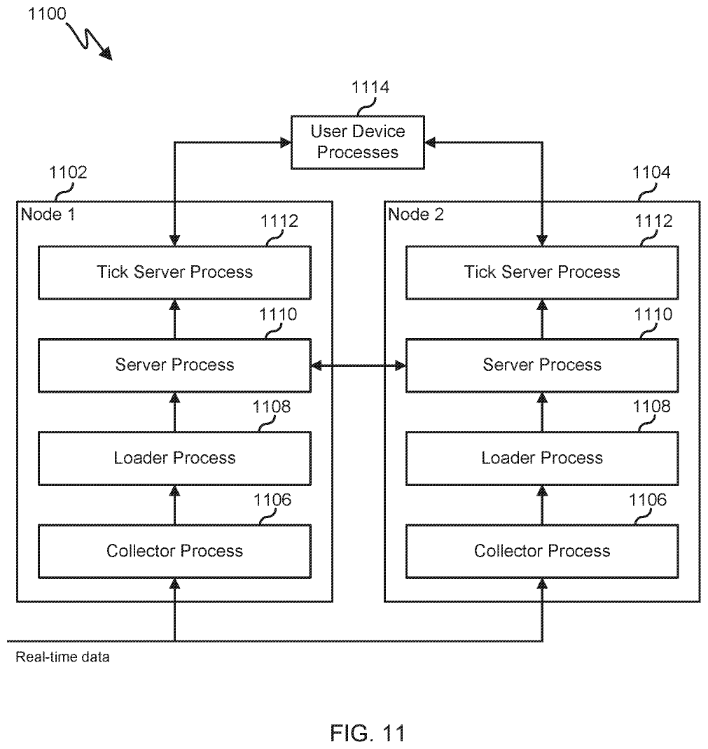

FIG. 11 illustrates an example process 1100 for serving real-time timeseries data in accordance with embodiments of this disclosure. For ease of explanation, the process 1100 is described as involving the use of the one or more applications 112 executed by the application server 106 of FIG. 1, and/or the database server 108, where the application server 106 and the database server 108 may be implemented using one or more devices 200 of FIG. 2. However, the process 1100 may be performed using any other suitable device(s) and in any other suitable system(s).

As shown in FIG. 11, a first node 1102 and a second node 1104 are executed, providing a distributed setup with potentially many nodes running in parallel. Data is replicated across the nodes 1102, 1104 to ensure they can be fault tolerant and so that the system can be scaled horizontally. Each node 1102, 1104 executes microservice processes that handle different parts of the data workflow. Each node 1102, 1104 includes a collector process 1106 that ingests real-time data pulled from various storage locations as described in this disclosure. Each node 1102, 1104 also include a loader process 1108 (which can be the chunk loader 1026 in some embodiments) which loads the collected real-time data to a server process 1110 (which can be the chunk server 1024 in some embodiments). Each node 1102, 1104 also executes a tick server process 1112 that can take the data loaded into the server process 1110, potentially manipulate or perform analysis on the data, and serve the data to one or more user device processes 1114, such as one or more processes running on user devices 102a-102d. In some embodiments, the data can be served to the user device processes 1114 in response to specific requests for data, routine/automated requests for data, or automatically streamed to the client devices in response to one original client request. The process 1100 ensures that real-time data can be served in response to requests at low latency, and even during spikes in activity, such as spikes in trading or market activity.

Although FIG. 11 illustrates one example of a process 1100 for serving real-time timeseries data, various changes may be made to FIG. 11. For example, various components and functions in FIG. 11 may be combined, further subdivided, replicated, or rearranged according to particular needs. Also, one or more additional components and functions may be included if needed or desired. Computing systems and processes come in a wide variety of configurations, and FIG. 11 does not limit this disclosure to any particular computing system or process.

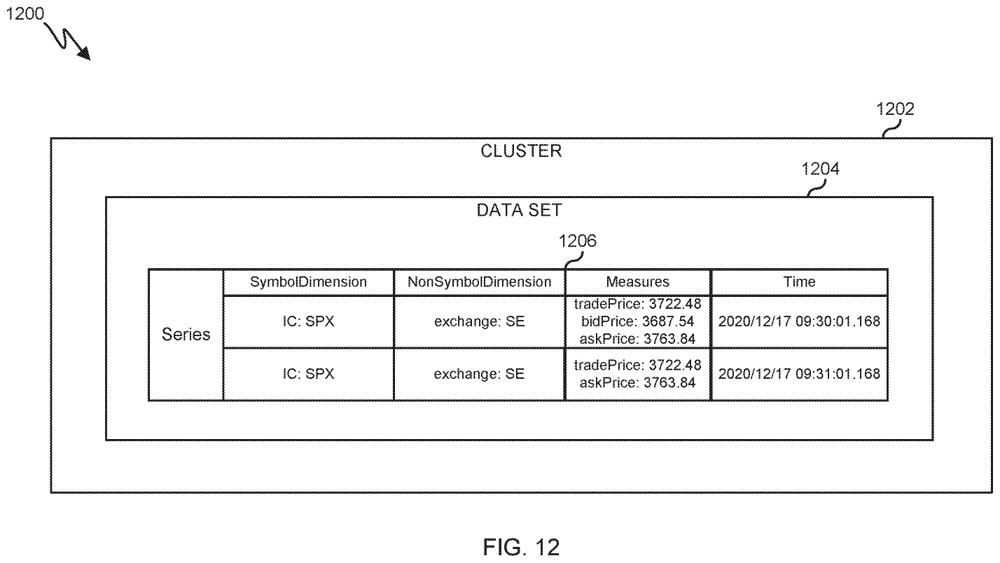

FIG. 12 illustrates an example timeseries data format 1200 in accordance with this disclosure. For ease of explanation, the timeseries data format 1200 of FIG. 12 may be used or provided by one or more applications 112 executed by the application server 106 of FIG. 1, and/or the database server 108, where the application server 106 and the database server 108 may be implemented using one or more devices 200 of FIG. 2. However, the timeseries data format 1200 may be used or provided by any other suitable device(s) and in any other suitable system(s).

As shown in FIG. 12, a cluster 1202 includes a dataset 1204. The dataset 1204 can include timeseries data 1206. The timeseries data 1206 can be formatted in columns and rows within the data set 1204. For example, the timeseries data 1206 can include a Symbol Dimension column that includes an identification code (IC) for each piece of timeseries data. For instance, the example timeseries data 1206 in FIG. 12 includes two rows with an IC value designating the S&P 500 Index (SPX). The example timeseries data 1206 also includes a NonSymbolDesignation column that lists, in this example, that the data is from a Stock Exchange. The example timeseries data 1206 also includes a Measures column that lists the relevant data metrics being measured, which are trade prices, bid prices, and ask prices in this example. The example timeseries data 1206 also includes a time column that includes a date/time stamp for the data, which can, in various embodiments of this disclosure, be used to determine in which storage location of the multi-tier database architecture the data is stored.

Although FIG. 12 illustrates one example of timeseries data format 1200, various changes may be made to FIG. 12. For example, various components in FIG. 12 may be combined, further subdivided, replicated, or rearranged according to particular needs, such as including additional clusters 1202 and/or data sets 1204. Also, one or more additional components may be included if needed or desired. Timeseries data can come in other formats, and FIG. 12 does not limit this disclosure to any particular formatting of timeseries data. For example, the timeseries data shown in FIG. 12 is but an example, and different values for the SymbolDimension, NonSymbolDimension, Measures, and Time columns can be used, based on the actual timeseries data retrieved (such as IoT device data), and the timeseries data can also include any number of rows of data.

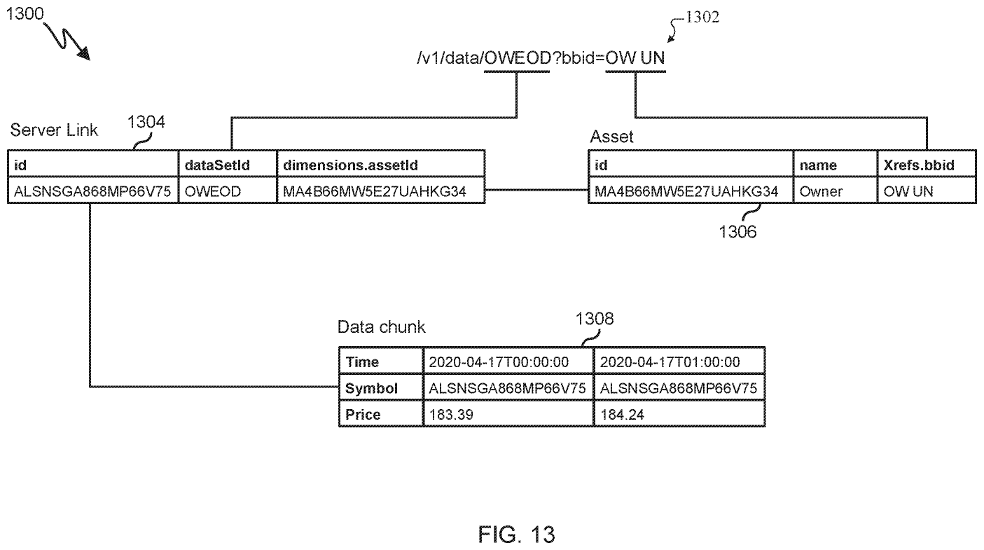

FIG. 13 illustrates an example data query anatomy 1300 in accordance with this disclosure. For ease of explanation, the data query anatomy 1300 of FIG. 13 may be used or provided by one or more applications 112 executed by the application server 106 of FIG. 1, and/or the database server 108, where the application server 106 and the database server 108 may be implemented using one or more devices 200 of FIG. 2. However, the data query anatomy 1300 may be used or provided by any other suitable device(s) and in any other suitable system(s).

As shown in FIG. 13, the data query anatomy 1300 can include a query 1302 that designates certain information including a dataset identifier (dataSetId), shown in this example as “OWEOD.” The dataset identifier can be used by one or more processes disclosed herein to look up the dataset at a server link 1304 that includes the dataset identifier. The server link 1304 has associated therewith data including a data identifier (shown as “ALSNSGA868MP66V75” in this example) that is associated with a data chunk 1308. The server link 1304 also has associated therewith an asset identifier (dimensions.assetId) shown here as “MA4B66MW5E27UAHKG34.” The asset identifier is associated with an asset data 1306. The asset data 1306 includes the asset identifier, an owner name, and an external references identifier (Xrefs.bbid) that is can also be referenced in the query 1302, as shown in FIG. 13.

The query 1302 thus provides access to the dataset and asset, leading to retrieval of the data chunk 1308. The data chunk 1308 includes timeseries data linked by the data identifier in the second row of the data chunk to the server link data 1304. The data chunk 1308 also includes in a first row a date/time stamp for the data, and a measured data value in the third row (a price in this example) although the measure data value can be for any type of data, such as IoT device measurements or statuses.

Although FIG. 13 illustrates one example of a data query anatomy 1300, various changes may be made to FIG. 13. For example, various components in FIG. 13 may be combined, further subdivided, replicated, or rearranged according to particular needs. Also, one or more additional components may be included if needed or desired. Timeseries data and data queries can come in a wide variety of configurations, and FIG. 13 does not limit this disclosure to any particular formatting of timeseries data or data queries.

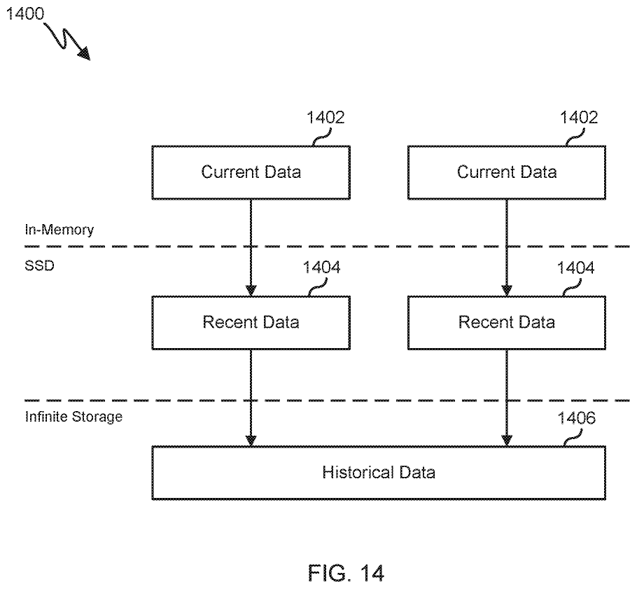

FIG. 14 illustrates an example multi-tier database/storage architecture 1400 in accordance with this disclosure. For ease of explanation, the architecture 1400 of FIG. 14 may be implemented using or provided by one or more applications 112 executed by the application server 106 of FIG. 1, and/or the database server 108, where the application server 106 and the database server 108 and may be implemented using one or more devices 200 of FIG. 2. In some embodiments, the architecture 1400 is at least part of the architecture 400. However, the architecture 1400 may be implemented using or provided by any other suitable device(s) and in any other suitable system(s).

As shown in FIG. 14, a plurality of current data 1402, that is, data recently sourced or otherwise acquired, can be stored in-memory, such as in fast access memory like RAM on one or more cloud server electronic devices, providing for rapid read times and faster transmission of the data to client devices. As also shown in FIG. 14, a plurality of recent data 1404, that is, data that was sourced or otherwise acquired earlier than the plurality of current data 1402, can be stored in medium access memory, such as on one or more SSDs. Historical data 1406, that is, data that is sourced or otherwise acquired earlier than the recent data 1404, can be stored in infinite storage. It will be understood that, here, the term infinite storage refers to potentially slower access, and potentially more cost-effective, memory/storage solutions, such as remote storage servers or slower hard disk drives, and is “infinite” in nature because the storage used provides a vast amount of storage resources for storing the historical data 1406. In some embodiments, determining which data falls into the categories of current data 1402, recent data 1404, and historical data 1406 can be determined using timing thresholds. For example, if data, based its associated timestamp, is older than one of the timing thresholds, the data can be stored in medium access or low access memory options. Considerations with respect to the current in-memory or medium access memory available can also be used in deciding when to move data to medium or low access memory options.

Although FIG. 14 illustrates one example of a multi-tier database/storage architecture 1400, various changes may be made to FIG. 14. For example, various components and functions in FIG. 14 may be combined, further subdivided, replicated, or rearranged according to particular needs. Also, one or more additional components and functions may be included if needed or desired. Computing architectures and systems come in a wide variety of configurations, and FIG. 14 does not limit this disclosure to any particular computing architecture or system.

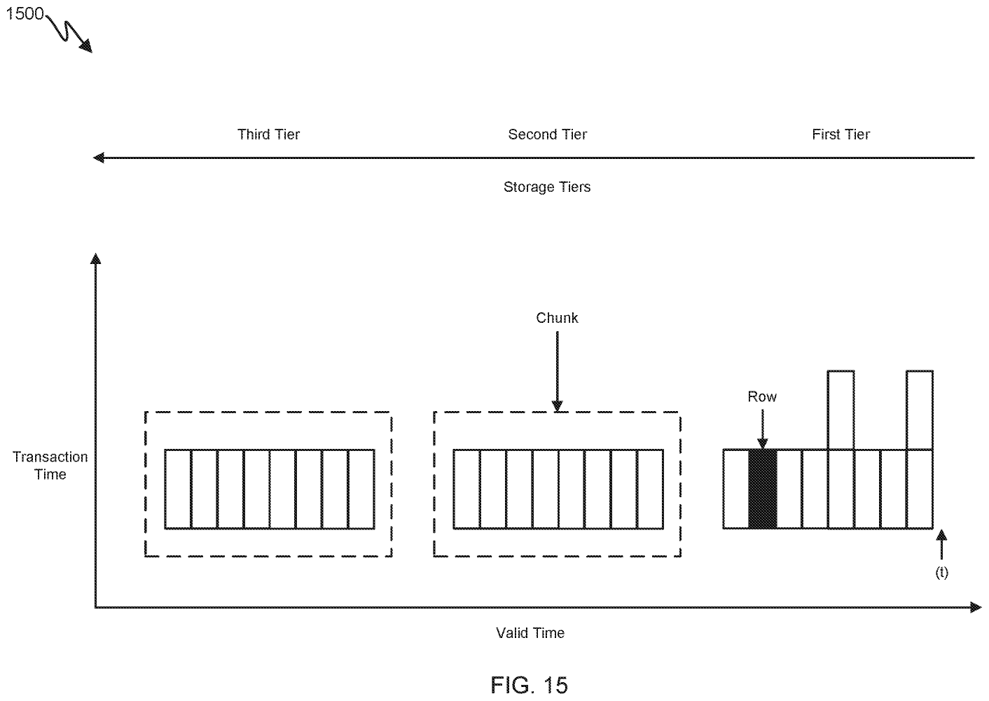

FIG. 15 illustrates an example temporal storage tier chart 1500 in accordance with this disclosure. For ease of explanation, the chart 1500 of FIG. 15 may represent actions taken by one or more applications 112 executed by the application server 106 of FIG. 1, and/or the database server 108, where the application server 106 and the database server 108 may be implemented using one or more devices 200 of FIG. 2. However, the chart 1500 may represent actions taken by any other suitable device(s) and in any other suitable system(s).

As shown in FIG. 15, the temporal storage tier chart 1500 shows that newer data can be stored in a first storage tier (such as in-memory), such that individual portions such as rows of the data can be quickly accessed from memory as needed. As data age increases, the data can be stored as chunks in second-tier storage or third-tier depending on the severity of the age. As also shown by they axis in the chart 1500, the determination of which data to store in which storage tier can be bitemporal, based on a function of the transaction time (when the event occurred) and valid time (when the event was logged by the system). Thus, for example, data with an older transaction time but a new valid time could still be stored in first-tier memory, or vice versa. It will be understood that the multi-tier database/storage structure can be customizable, such as by customizing the number of storage tiers to be used or customizing the threshold at which data is stored in the different tiers.

Although FIG. 15 illustrates one example of a temporal storage tier chart 1500, various changes may be made to FIG. 15. For example, various components in FIG. 15 may be combined, further subdivided, replicated, or rearranged according to particular needs. Also, one or more additional components may be included if needed or desired.

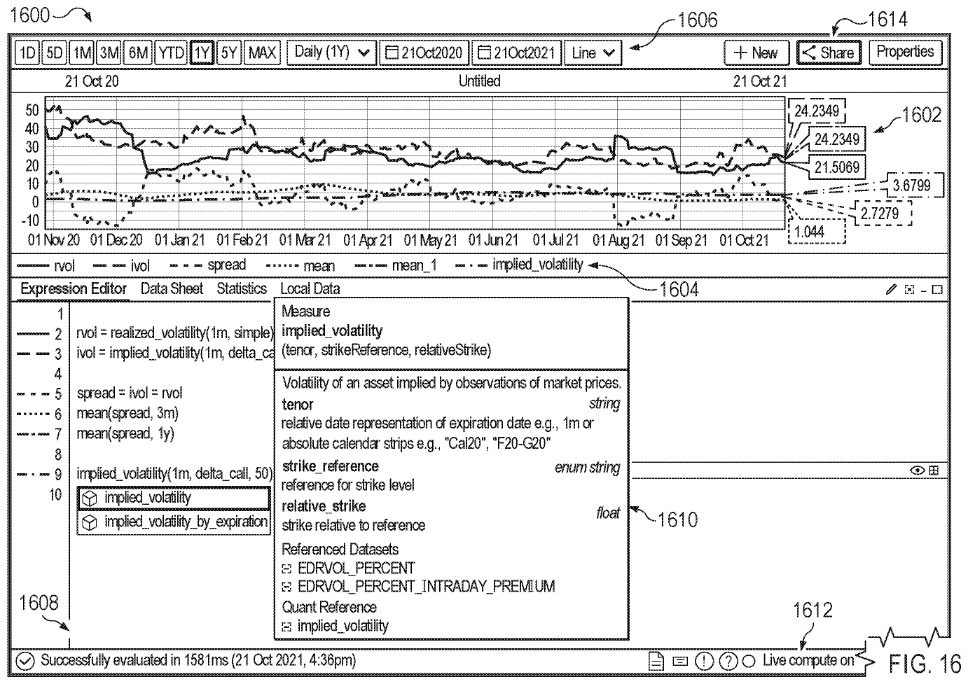

FIG. 16 illustrates an example data analysis user interface 1600 in accordance with this disclosure. For ease of explanation, the user interface 1600 of FIG. 16 may be implemented using or provided by one or more applications (such as the plot tool 440) executed by one or more of the user devices 102a-102d of FIG. 1, and may be implemented using one or more devices 200 of FIG. 2. However, the user interface 1600 may be implemented using or provided by any other suitable device(s) or applications, such as by the application server 106, and in any other suitable system(s).

As shown in FIG. 16, the user interface 1600 includes a data plot area 1602 that can include various visual representations of timeseries data over time, such as line graphs as shown in this example. The charted data can include various charted parameters shown in a legend 1604, such as realized volatility (rvol), implied volatility (ivol), implied volatility, spread, and mean, as shown in this example. A parameters area 1606 can include options for setting various filtering parameters on the data, such as timing parameters including a filter on how far to look back for the data, how granular the data should be (such as hourly, daily, etc.), and date ranges, and options for how the data should be presented (set to “line” in this example).

The user interface 1600 can also include information and results of performing data analysis functions on the data such as a mean function or a correlation function, measuring asset volatility, etc. in a results window 1608. Additionally, an information window 1610 can be included in the user interface 1600 that provides the user with explanations of what the different data metrics mean, such as shown in this example where the information window 1610 provides an explanation of implied volatility. The user interface 1600 can also include an indicator 1612 that indicates live or real-time data retrieval and analysis is available or toggled on. The user interface 1600 can also include a menu area 1614 that provides various functions such as starting a new analysis or chart, sharing the current analysis or chart with other users or devices, or viewing properties of the current chart or the application in general.

Although FIG. 16 illustrates one example of a data analysis user interface 1600, various changes may be made to FIG. 16. For example, various components and functions in FIG. 16 may be combined, further subdivided, replicated, or rearranged according to particular needs. Also, one or more additional components and functions may be included if needed or desired. User interfaces and application programs can come in a wide variety of configurations, and FIG. 16 does not limit this disclosure to any particular user interface or application program.

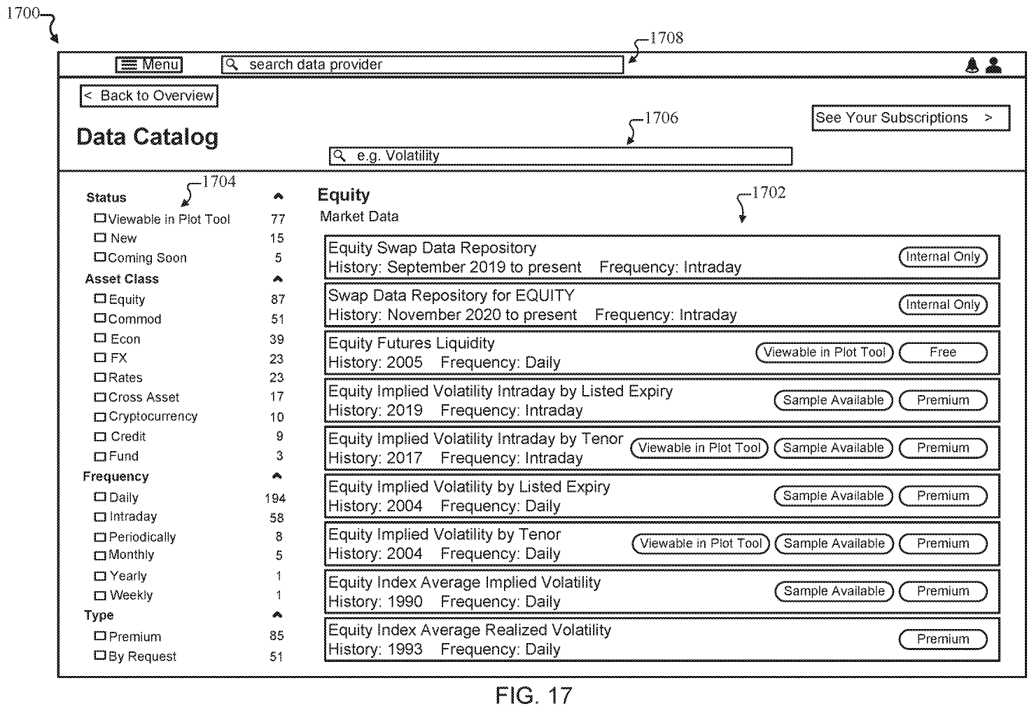

FIG. 17 illustrates an example data catalog user interface 1700 in accordance with this disclosure. For ease of explanation, the user interface 1700 of FIG. 17 may be implemented using or provided by one or more applications executed by one or more of the user devices 102a-102d of FIG. 1, and may be implemented using one or more devices 200 of FIG. 2. However, the user interface 1700 may be implemented using or provided by any other suitable device(s) or applications, such as by the application server 106, and in any other suitable system(s).

In some embodiments of this disclosure, such as also described with respect to FIGS. 8A and 8B, a user or organization can provide via the systems and architectures of this disclosure, a centralized catalog of data sources or feeds that can be made available programmatically or via a user interface. For example, a user interface populated with different available data sources could be provided, and users could select any of the data feeds to cause the system to access the shared data APIs and import the shared data feed in a matter of seconds. In some embodiments, auto-generated code snippets appearing on each dataset can be copied directly into other user applications to access the data feeds. This allows for data feeds to be accessed through a single API, irrespective of database location.

For instance, as shown in FIG. 17, the user interface 1700 includes a listing 1702 of available data sets in the catalog. A user may click, touch, or otherwise select a data set from the listing 1702 to view information related to the data set. The data sets can be tagged with various categorical identifiers or properties, such as if a dataset is private or for internal use only, if the data set is free for others to access and/or use, if the dataset is viewable in a plot tool such as the plot tool 440, if the data set is a premium data set requiring a purchase or subscription to use, if a sample of the data is available, etc. The categories of the data sets can be filtered using a number of filtering options 1704 in the user interface 1700, such as based on data set status, asset class, time frequency, availability type, or other categories.

The user interface 1700 can also include a search bar 1706 to allow users to search available data sets provided by a user or organization. The data sets can thus be provided by a user or organization for sharing with other users or organizations, and an additional search bar 1708 can be provided to search available users or organizations that are offering shared data sets. Other user interface elements can be included, such as a menu button and a button to view current data set subscriptions, as shown in FIG. 17.

Although FIG. 17 illustrates one example of data catalog user interface 1700, various changes may be made to FIG. 17. For example, various components and functions in FIG. 17 may be combined, further subdivided, replicated, or rearranged according to particular needs. Also, one or more additional components and functions may be included if needed or desired. User interfaces and application programs can come in a wide variety of configurations, and FIG. 17 does not limit this disclosure to any particular user interface or application program.

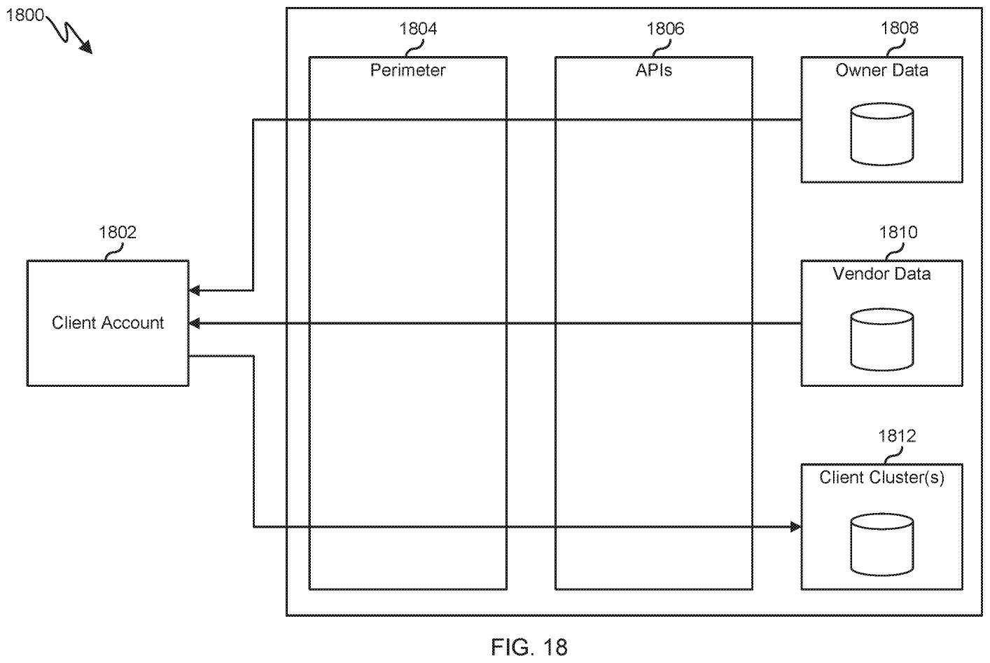

FIG. 18 illustrates an example data sharing architecture 1800 in accordance with this disclosure. For ease of explanation, the architecture 1800 of FIG. 18 may be implemented using or provided by one or more applications 112 executed by the application server 106 of FIG. 1, and/or the database server 108, where the application server 106 and the database server 108 and may be implemented using one or more devices 200 of FIG. 2. In some embodiments, the architecture 1800 is at least part of the architecture 400. However, the architecture 1800 may be implemented using or provided by any other suitable device(s) and in any other suitable system(s).

The architecture 1800 includes a client account 1802 that is associated with a party or entity that uses the various systems and architectures of this disclosure. As described in this disclosure such as with respect to FIGS. 8A, 8B, and 17, clients can utilize shared data sets to perform data analyses or supplement their own data analyses using their own data. For example, as shown in FIG. 18, the client account 1802 can access shared data sets across a perimeter 1804 of the cloud platform using one or more APIs 1806. For example, one or more owner data sets 1808 can be access that belong to a owner/provider of such data sets, such as the owner of the various data sets shown in FIG. 17. In some embodiments, the owner of the shared owner data sets 1808 can be an owner of provider of the services offered under the cloud platform of the embodiments of this disclosure.

The shared owner data sets 1808 can be accessed by the client account 1802 based on permissions established between the owner of the shared owner data sets 1808 and the client account 1802. Similarly, other vendor data sets 1810 from other parties or entities can also be shared with the client account 1802. The owner data sets 1808 and the vendor data sets 1810 can be real-time data feeds, stored historical data, and/or data analysis results, such raw data sets or normalized data sets. Client data stored in client-specific clusters 1812 can be used in combination with the shared data sets 1808, 1810. In some embodiments, real-time vendor feeds of the vendor data sets 1810 can be provided in association with the owner data sets 1808, and/or provided by the owner of the owner data sets 1808 as separate data sets by using the owner's cloud platform architectures and services to serve the data sets to the client account 1802. For example, the vendor data sets 1810 can require significant subject matter expert knowledge to normalize for a variety of applications, such as financial applications, and in some embodiments the owner can take the vendor data sets 1810 and normalize them accordingly for the benefit of clients. Clients can also use the shared data to compute and store derived calculations to view and analyze, such as using a data analysis tool such as the plot tool 440 and/or an application providing the data analysis user interface 1600.

Although FIG. 18 illustrates one example of a data sharing architecture 1800, various changes may be made to FIG. 18. For example, various components and functions in FIG. 18 may be combined, further subdivided, replicated, or rearranged according to particular needs. Also, one or more additional components and functions may be included if needed or desired. Computing architectures and systems come in a wide variety of configurations, and FIG. 18 does not limit this disclosure to any particular computing architecture or system.

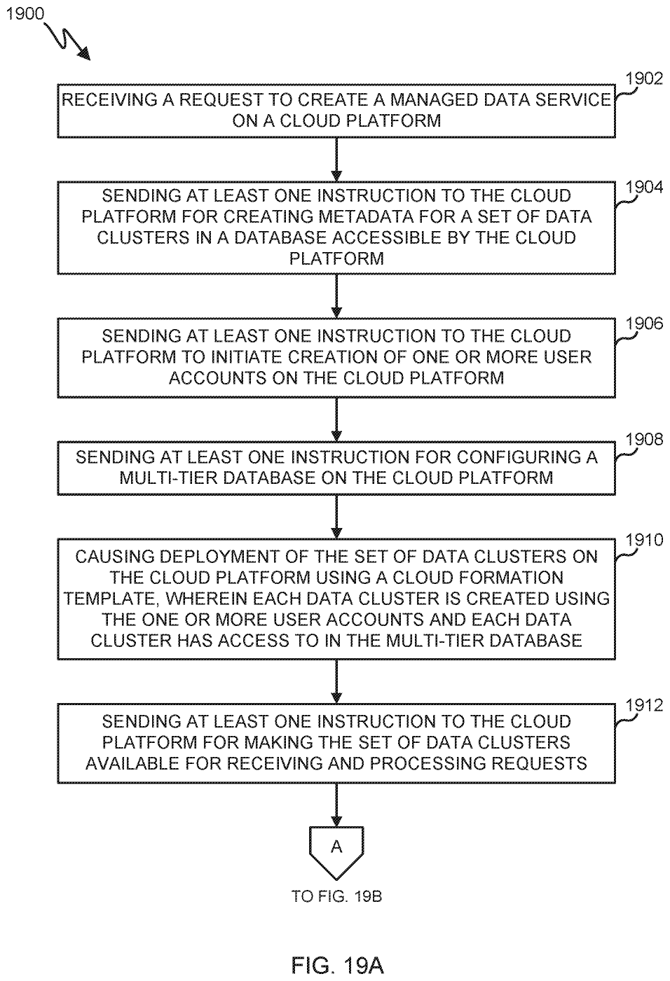

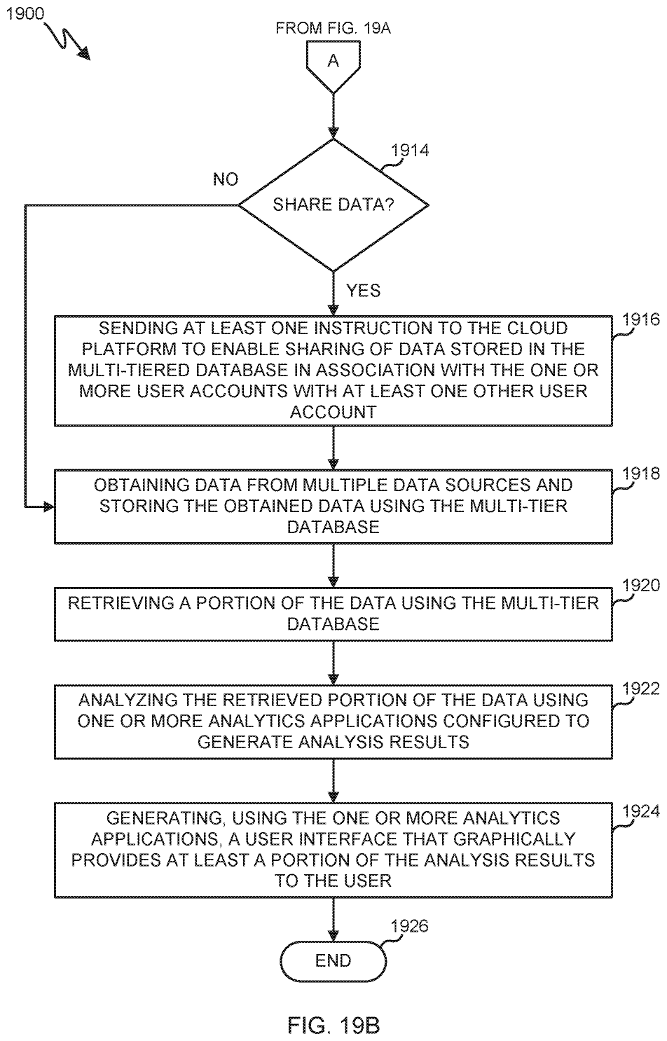

FIGS. 19A and 19B illustrate an example method 1900 for deploying and executing managed data services in accordance with this disclosure. For ease of explanation, the method 1900 shown in FIGS. 19A and 19B is described as being performed using an electronic device such as one of the user devices 102a-102d of FIG. 1, the example device 200 of FIG. 2, or the computer system 300 of FIG. 3. However, the method 1900 could be performed using any other suitable device(s) and in any other suitable system(s).

At block 1902, a processor of the electronic device receives a request to create a managed data service on a cloud platform. At block 1904, the processor sends, such as via communications unit 206, at least one instruction to the cloud platform for creating metadata for a set of data clusters in a database accessible by the cloud platform. At block 1906, the processor sends at least one instruction to the cloud platform to initiate creation of one or more user accounts on the cloud platform. In some embodiments, sending the at least one instruction to the cloud platform to initiate the creation of the one or more user accounts on the cloud platform includes triggering a serverless step function. At block 1908, the processor sends at least one instruction for configuring a multi-tier database on the cloud platform. In some embodiments, the multi-tier database is configured to store a first portion of data in memory, a second portion of data in a secondary storage device, and a third portion of data in an object storage service. In some embodiments, data is stored in the multi-tier database based on a temporal parameter, such that the first portion of data is recent data, the second portion of data is less recent data, and the third portion of data is least recent data.

At block 1910, the processor causes deployment of the set of data clusters on the cloud platform using a cloud formation template, such that each data cluster is created using the one or more user accounts and each data cluster has access to in the multi-tier database. At block 1912, the processor sends at least one instruction to the cloud platform for making the set of data clusters available for receiving and processing requests. At decision block 1914, the processor determines whether data associated with the newly created data clusters is to be shared. For example, as discussed in this disclosure such as with respect to FIGS. 8A and 8B, and FIG. 17, data may be shared between users or organizations using the systems, architectures, and processes of this disclosure.

If, at decision block 1914, the processor determines data is not to be shared, at least at this time, the method 1900 moves to block 1918. If, at decision block 1914, the processor determines data is to be shared, the method 1900 moves to block 1916. At block 1916, the processor sends at least one instruction to the cloud platform to enable sharing of data stored in the multi-tiered database in association with the one or more user accounts with at least one other user account. In some embodiments, enabling the sharing of the data with the at least one other user account includes allowing at least one cluster associated with the at least one other user account to access the data stored in the multi-tiered database using at least one of a shared gateway and a data application programming interface.

At block 1918, the processor obtains data from multiple data sources and stores the obtained data using the multi-tier database. At block 1920, the processor retrieves a portion of the data using the multi-tier database. At block 1922, the processor analyzes the retrieved portion of the data using one or more analytics applications configured to generate analysis results. At block 1924, the processor generates, using the one or more analytics applications, a user interface that graphically provides at least a portion of the analysis results to the user. In some embodiments, the user interface is configured to provide updated analysis results to the user in real-time. The process 1900 ends at block 1926.

Although FIGS. 19A and 19B illustrate one example of a method 1900 for deploying and executing managed data services, various changes may be made to FIGS. 19A and 19B. For example, while shown as a series of steps, various steps in FIGS. 19A and 19B could overlap, occur in parallel, occur in a different order, or occur any number of times.

According to some embodiments, the systems, architectures, and processes disclosed herein can be implemented in a hosted environment such as the AMAZON WEB SERVICES (AWS) platform, the GOOGLE CLOUD platform, or MICROSOFT AZURE. For example, if implemented on the AWS platform, the multi-tier architecture could be implemented with a combination of ELASTIC COMPUTE CLOUD (EC2), for the in-memory data and compute, ELASTIC BLOCK STORE (EBS) for fast SSD-like access, and SIMPLE STORAGE SERVICE (S3) for the infinite storage layer. EC2 is a web service that provides secure, resizable compute capacity in the cloud. However, other embodiments can use any other service that allows resizing of compute capacity. EBS is a scalable, high-performance, block-storage service. However, other embodiments can use any other storage service that supports features used by various components of the system. S3 is an object storage service. However, other embodiments can use any other object storage service that supports features used by various components of the system. For example, in some embodiments, the fast access memory 1015 can be implemented using ECS to provide for fast data access and in-memory computation, the storage volume(s) 1016 can be implemented using EBS, and the object storage server(s) can be implemented using S3.

In some embodiments, the system can use AMAZON DATA EXCHANGE (ADX) as a service that supports finding, subscribing to, and using third-party data in the cloud, such as for implementing the data exchange service 414. However, other embodiments can use any other data exchange service that supports features used by various components of the system. In some embodiments, the system can use AWS GLUE as a serverless data integration service that allows the system to discover, prepare, and combine data for analytics, machine learning, and application development, such as to implement the ETL tool 416. However, other embodiments can use any other data integration service that supports features used by various components of the system.

As other examples, in some embodiments, AWS SHIELD can be used to implement the DDoS Protection Service 408, AWS WAF can be used to implement the WAF service 410, KONG GATEWAYS can be used to implement the API gateways 424, AURORA can be used to implement the SQL database 518, and DYNAMODB can be used to implement the NoSQL database 512. For example, DYNAMODB is a fully managed, serverless, key-value NoSQL database that supports built-in security, continuous backups, automated multi-region replication, in-memory caching, and data export tools. However, other embodiments can use other databases that support the features used by various components of the system. As yet other examples, the cache service 510 can be implemented using ELASTIC CACHE and the search service 516 can be implemented using ELASTIC SEARCH, the cloud formation service 432 can be implemented using AWS CLOUD DEVELOPMENT KIT (CDK), the key management service can be implemented using AWS KEY MANAGEMENT SERVICE, and PROMETHEUS MDAAS can be used to implement the MDaaS control 906.

In some embodiments, LAMBDA functions can be used to implement the compute service 418. LAMBDA is a compute service that executes code without provisioning or managing servers, and can run the code on a high-availability compute infrastructure and can perform administration of the compute resources, including server and operating system maintenance, capacity provisioning and automatic scaling, code monitoring and logging. Instructions for executing using LAMBDA may be provided as LAMBDA functions. A LAMBDA function represents a resource that can be invoked to run code in LAMBDA. A function has code to process the events that are passed into the function or that other cloud platform services send to the function. LAMBDA function code is deployed using deployment packages. In some embodiments, NOMAD can be used for process and workload orchestration, such as for deploying containers and non-containerized applications, such as for implementing the node management service 1012. In some embodiments, storage of data chunks can be implemented using CHUNKSTORE. However, use of such hosted environments or applications as described above is not required by this disclosure.

In one example embodiment, a method comprises receiving a request to create a managed data service on a cloud platform, sending at least one instruction to the cloud platform for creating metadata for a set of data clusters in a database accessible by the cloud platform, sending at least one instruction to the cloud platform to initiate creation of one or more user accounts on the cloud platform, sending at least one instruction for configuring a multi-tier database on the cloud platform, causing deployment of the set of data clusters on the cloud platform using a cloud formation template, wherein each data cluster is created using the one or more user accounts and each data cluster has access to the multi-tier database, and sending at least one instruction to the cloud platform for making the set of data clusters available for receiving and processing requests.

In one or more of the above examples, the multi-tier database is configured to store a first portion of data in memory, a second portion of data in a secondary storage device, and a third portion of data in an object storage service.

In one or more of the above examples, data is stored in the multi-tier database based on a temporal parameter, wherein the first portion of data is recent data, the second portion of data is less recent data, and the third portion of data is least recent data.

In one or more of the above examples, sending the at least one instruction to the cloud platform to initiate the creation of the one or more user accounts on the cloud platform includes triggering a serverless step function.

In one or more of the above examples, the method further comprises obtaining data from multiple data sources and storing the obtained data using the multi-tier database, retrieving a portion of the data using the multi-tier database, analyzing the retrieved portion of the data using one or more analytics applications configured to generate analysis results, and generating, using the one or more analytics applications, a user interface that graphically provides at least a portion of the analysis results to the user, wherein the user interface is configured to provide updated analysis results to the user in real-time.

In one or more of the above examples, the method further comprises sending at least one instruction to the cloud platform to enable sharing of data stored in the multi-tiered database in association with the one or more user accounts with at least one other user account.

In one or more of the above examples, enabling the sharing of the data with the at least one other user account includes allowing at least one cluster associated with the at least one other user account to access the data stored in the multi-tiered database using at least one of a shared gateway and a data application programming interface.

In one or more of the above examples, the cloud formation template is pre-stored at a storage location of the cloud platform.

In one or more of the above examples, the cloud formation template is included in the instructions sent to the cloud platform to create the data clusters and/or the multi-tier database.

In another example embodiment, an apparatus comprises at least one processor supporting managed data services, and the at least one processor is configured to receive a request to create a managed data service on a cloud platform, send at least one instruction to the cloud platform for creating metadata for a set of data clusters in a database accessible by the cloud platform, send at least one instruction to the cloud platform to initiate creation of one or more user accounts on the cloud platform, send at least one instruction for configuring a multi-tier database on the cloud platform, cause deployment of the set of data clusters on the cloud platform using a cloud formation template, wherein each data cluster is created using the one or more user accounts and each data cluster has access to the multi-tier database, and send at least one instruction to the cloud platform for making the set of data clusters available for receiving and processing requests.

In one or more of the above examples, the multi-tier database is configured to store a first portion of data in memory, a second portion of data in a secondary storage device, and a third portion of data in an object storage service.

In one or more of the above examples, data is stored in the multi-tier database based on a temporal parameter, wherein the first portion of data is recent data, the second portion of data is less recent data, and the third portion of data is least recent data.

In one or more of the above examples, to send the at least one instruction to the cloud platform to initiate the creation of the one or more user accounts on the cloud platform, the at least one processor is further configured to trigger a serverless step function.

In one or more of the above examples, the at least one processor is further configured to obtain data from multiple data sources and storing the obtained data using the multi-tier database, retrieve a portion of the data using the multi-tier database, analyze the retrieved portion of the data using one or more analytics applications configured to generate analysis results, and generate, using the one or more analytics applications, a user interface that graphically provides at least a portion of the analysis results to the user, wherein the user interface is configured to provide updated analysis results to the user in real-time.

In one or more of the above examples, the at least one processor is further configured to send at least one instruction to the cloud platform to enable sharing of data stored in the multi-tiered database in association with the one or more user accounts with at least one other user account.

In one or more of the above examples, to enable the sharing of the data with the at least one other user account, the at least one processor is further configured to allow at least one cluster associated with the at least one other user account to access the data stored in the multi-tiered database using at least one of a shared gateway and a data application programming interface.

In one or more of the above examples, the cloud formation template is pre-stored at a storage location of the cloud platform.

In one or more of the above examples, the cloud formation template is included in the instructions sent to the cloud platform to create the data clusters and/or the multi-tier database.

In another example embodiment, a non-transitory computer readable medium contains instructions that support managed data services and that when executed cause at least one processor to receive a request to create a managed data service on a cloud platform, send at least one instruction to the cloud platform for creating metadata for a set of data clusters in a database accessible by the cloud platform, send at least one instruction to the cloud platform to initiate creation of one or more user accounts on the cloud platform, send at least one instruction for configuring a multi-tier database on the cloud platform, cause deployment of the set of data clusters on the cloud platform using a cloud formation template, wherein each data cluster is created using the one or more user accounts and each data cluster has access to the multi-tier database, send at least one instruction to the cloud platform for making the set of data clusters available for receiving and processing requests.

In one or more of the above examples, the multi-tier database is configured to store a first portion of data in memory, a second portion of data in a secondary storage device, and a third portion of data in an object storage service.

In one or more of the above examples, data is stored in the multi-tier database based on a temporal parameter, wherein the first portion of data is recent data, the second portion of data is less recent data, and the third portion of data is least recent data.

In one or more of the above examples, the non-transitory computer readable medium further contains instructions that when executed cause the at least one processor to obtain data from multiple data sources and storing the obtained data using the multi-tier database, retrieve a portion of the data using the multi-tier database, analyze the retrieved portion of the data using one or more analytics applications configured to generate analysis results, and generate, using the one or more analytics applications, a user interface that graphically provides at least a portion of the analysis results to the user, wherein the user interface is configured to provide updated analysis results to the user in real-time.

In one or more of the above examples, the non-transitory computer readable medium further contains instructions that when executed cause the at least one processor to send at least one instruction to the cloud platform to enable sharing of data stored in the multi-tiered database in association with the one or more user accounts with at least one other user account.

In one or more of the above examples, to enable the sharing of the data with the at least one other user account, the non-transitory computer readable medium further contains instructions that when executed cause the at least one processor to allow at least one cluster associated with the at least one other user account to access the data stored in the multi-tiered database using at least one of a shared gateway and a data application programming interface.

In one or more of the above examples, the cloud formation template is pre-stored at a storage location of the cloud platform.

In one or more of the above examples, the cloud formation template is included in the instructions sent to the cloud platform to create the data clusters and/or the multi-tier database.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
receiving a request to create a managed data service on a cloud platform;
sending at least one instruction to the cloud platform for creating metadata for a set of data clusters in a database accessible by the cloud platform;
sending at least one instruction to the cloud platform to initiate creation of one or more user accounts on the cloud platform;
sending at least one instruction for configuring a multi-tier database on the cloud platform;
causing deployment of the set of data clusters on the cloud platform using a cloud formation template, wherein each data cluster is created using the one or more user accounts and each data cluster has access to the multi-tier database; and
sending at least one instruction to the cloud platform for making the set of data clusters available for receiving and processing requests.

2. The method of claim 1, wherein the multi-tier database is configured to store:
a first portion of data in memory;
a second portion of data in a secondary storage device; and
a third portion of data in an object storage service.

3. The method of claim 2, wherein data is stored in the multi-tier database based on a temporal parameter, wherein the first portion of data is recent data, the second portion of data is less recent data, and the third portion of data is least recent data.

4. The method of claim 1, wherein sending the at least one instruction to the cloud platform to initiate the creation of the one or more user accounts on the cloud platform includes triggering a serverless step function.

5. The method of claim 1, further comprising:
obtaining data from multiple data sources and storing the obtained data using the multi-tier database;
retrieving a portion of the data using the multi-tier database;
analyzing the retrieved portion of the data using one or more analytics applications configured to generate analysis results; and
generating, using the one or more analytics applications, a user interface that graphically provides at least a portion of the analysis results to the user,
wherein the user interface is configured to provide updated analysis results to the user in real-time.

6. The method of claim 1, further comprising:
sending at least one instruction to the cloud platform to enable sharing of data stored in the multi-tiered database in association with the one or more user accounts with at least one other user account.

7. The method of claim 6, wherein enabling the sharing of the data with the at least one other user account includes allowing at least one cluster associated with the at least one other user account to access the data stored in the multi-tiered database using at least one of a shared gateway and a data application programming interface.

8. An apparatus comprising:
at least one processor supporting managed data services, the at least one processor configured to:
receive a request to create a managed data service on a cloud platform;
send at least one instruction to the cloud platform for creating metadata for a set of data clusters in a database accessible by the cloud platform;
send at least one instruction to the cloud platform to initiate creation of one or more user accounts on the cloud platform;
send at least one instruction for configuring a multi-tier database on the cloud platform;
cause deployment of the set of data clusters on the cloud platform using a cloud formation template, wherein each data cluster is created using the one or more user accounts and each data cluster has access to the multi-tier database; and
send at least one instruction to the cloud platform for making the set of data clusters available for receiving and processing requests.

9. The apparatus of claim 8, wherein the multi-tier database is configured to store:
a first portion of data in memory;
a second portion of data in a secondary storage device; and
a third portion of data in an object storage service.

10. The apparatus of claim 9, wherein data is stored in the multi-tier database based on a temporal parameter, wherein the first portion of data is recent data, the second portion of data is less recent data, and the third portion of data is least recent data.

11. The apparatus of claim 8, wherein, to send the at least one instruction to the cloud platform to initiate the creation of the one or more user accounts on the cloud platform, the at least one processor is further configured to trigger a serverless step function.

12. The apparatus of claim 8, wherein the at least one processor is further configured to:
obtain data from multiple data sources and storing the obtained data using the multi-tier database;
retrieve a portion of the data using the multi-tier database;
analyze the retrieved portion of the data using one or more analytics applications configured to generate analysis results; and
generate, using the one or more analytics applications, a user interface that graphically provides at least a portion of the analysis results to the user,
wherein the user interface is configured to provide updated analysis results to the user in real-time.

13. The apparatus of claim 8, wherein the at least one processor is further configured to:
send at least one instruction to the cloud platform to enable sharing of data stored in the multi-tiered database in association with the one or more user accounts with at least one other user account.

14. The apparatus of claim 13, wherein, to enable the sharing of the data with the at least one other user account, the at least one processor is further configured to allow at least one cluster associated with the at least one other user account to access the data stored in the multi-tiered database using at least one of a shared gateway and a data application programming interface.

15. A non-transitory computer readable medium containing instructions that support managed data services and that when executed cause at least one processor to:
receive a request to create a managed data service on a cloud platform;
send at least one instruction to the cloud platform for creating metadata for a set of data clusters in a database accessible by the cloud platform;
send at least one instruction to the cloud platform to initiate creation of one or more user accounts on the cloud platform;
send at least one instruction for configuring a multi-tier database on the cloud platform;
cause deployment of the set of data clusters on the cloud platform using a cloud formation template, wherein each data cluster is created using the one or more user accounts and each data cluster has access to the multi-tier database; and
send at least one instruction to the cloud platform for making the set of data clusters available for receiving and processing requests.

16. The non-transitory computer readable medium of claim 15, wherein the multi-tier database is configured to store:
a first portion of data in memory;
a second portion of data in a secondary storage device; and
a third portion of data in an object storage service.

17. The non-transitory computer readable medium of claim 16, wherein data is stored in the multi-tier database based on a temporal parameter, wherein the first portion of data is recent data, the second portion of data is less recent data, and the third portion of data is least recent data.

18. The non-transitory computer readable medium of claim 15, further containing instructions that when executed cause the at least one processor to:
obtain data from multiple data sources and storing the obtained data using the multi-tier database;
retrieve a portion of the data using the multi-tier database;
analyze the retrieved portion of the data using one or more analytics applications configured to generate analysis results; and
generate, using the one or more analytics applications, a user interface that graphically provides at least a portion of the analysis results to the user,
wherein the user interface is configured to provide updated analysis results to the user in real-time.

19. The non-transitory computer readable medium of claim 15, further containing instructions that when executed cause the at least one processor to:
send at least one instruction to the cloud platform to enable sharing of data stored in the multi-tiered database in association with the one or more user accounts with at least one other user account.

20. The non-transitory computer readable medium of claim 13, wherein, to enable the sharing of the data with the at least one other user account, the non-transitory computer readable medium further contains instructions that when executed cause the at least one processor to:
allow at least one cluster associated with the at least one other user account to access the data stored in the multi-tiered database using at least one of a shared gateway and a data application programming interface.
